(19) United States
(12) Patent Application Publication
(10) Pub. No.: US 2013/0282415 A1
(43) Pub. Date: Oct. 24, 2013

(54) PRODUCTION MANAGEMENT DEVICE, PRODUCTION MANAGEMENT SYSTEM, METHOD OF CONTROLLING PRODUCTION MANAGEMENT DEVICE, CONTROL PROGRAM, AND RECORDING MEDIUM

(71) Applicants: Hiroshi Saito, Kyoto-shi (JP); Shinichi Mukaigawa, Kyoto-shi (JP)

(72) Inventors: Hiroshi Saito, Kyoto-shi (JP); Shinichi Mukaigawa, Kyoto-shi (JP)

(73) Assignee: OMRON CORPORATION, Kyoto (JP)

(21) Appl. No.: 13/884,757

(22) PCT Filed: Mar. 23, 2011
(86) PCT No.: PCT/JP2011/056898

§ 371 Date: Jul. 8, 2013

(30) Foreign Application Priority Data
Nov. 29, 2010 (JP) JP2010-265505

(51) Int. Cl. G06Q 10/06

(52) U.S. Cl. CPC G06Q 10/063
USPC 705/7.11

(57) ABSTRACT

Disclosed is a production management device configured to monitor the state of a production device which, by consuming a resource (electric power and so forth) produces a product with a change in a physical amount (temperature and so forth) in the production environment. The production management device includes an environment change physical amount measurement unitconfigured to acquire as environment change physical amounts the physical amount of the production environment that has been changed by the production device consuming the resource, and a state determining unit configured to determine the state of the production device in response to the acquired environment change physical amounts.

### CROSS-REFERENCE TO RELATED APPLICATIONS

This application claims the benefit of priority from Japanese Patent Application No. 2010-265505, filed 29 Nov. 2010, and International Patent Application No. PCT/JP2011/056898 filed 23 Mar. 2011 and designating the United States, the entire contents of which is incorporated herein by reference for all purposes.

### BACKGROUND

The present invention relates to a production management device that monitors a production device to determine a state of the production device, a production management system, a method of controlling the production management device, and a recording medium.

Conventionally, there is production management technology that monitors an operating state of a production device (a facility) to sense abnormality of the production device or to extract waste of the production device or a whole production line.

Such a production management technology can sense the abnormality to prevent an accident before happens, suppress ejection of a reject, or remove the waste to enhance production efficiency. The production management technology is an important element for a person who operates the production line in improving safety and productivity, and various devices have been made.

For example, Patent Document 1 (Japanese Unexamined Patent Publication No. 2002-304207 (published on Oct. 18, 2002)) discloses a method of monitoring a power used amount of a machine tool to determine the operating state (such as a stop state and a running state) of the machine tool or sense the abnormality of the machine tool.

Nowadays, from the viewpoints of preservation of a global environment and economic efficiency, a consumption resource (energy such as the power) of the production device is recognized to extract the waste of resource consumption.

The above conventional technology has a configuration in which the operating state or non-operating state of the production device is determined based on the amount of power used. Conventionally, a production state or a non-production state of the production device is determined by sensing a work piece (a work object) input to the production device or work generated from the input of the work piece.

However, even if the state determination results are used, unfortunately a grade of the consumption resource cannot correctly be discriminated from the viewpoint of extracting the waste.

As used herein, the grade of the consumption resource from the viewpoint of extracting the waste means that the resource consumption is discriminated from the viewpoint of whether the “consumption” of the resource contributes to the production of a product. For example, the resource consumption is determined to be not wasted in the case that the consumption of the resource contributes to the production (inevitable consumption necessary to produce the product), the resource consumption is determined to be wasted in the case that the consumption of the resource does not contribute to the production (the unnecessary consumption that has no influence on the normal production, but causes damage).

More specifically, even in the operating (production) state, it is conceivable that actually the work piece is not input, or that the reject is produced. In such cases, from the viewpoint of extracting the waste, “the resource consumption is the waste” may be determined even for the consumption during the production. On the other hand, even in the non-operating (non-production) state, sometimes the resource may be consumed in order to maintain the state in which the production device can normally produce the product. In such cases, from the viewpoint of extracting the waste, “the resource consumption is necessary (not wasted)” may be determined even for the consumption during the non-production.

In view of the foregoing, an object of at least an embodiment of the present invention is to construct a production management device that can correctly discriminate the waste of the consumption resource by properly determining the state of the production device irrespective of the operation/non-operation of the production device, a production management system, a method of controlling the production management device, a control program, and a recording medium.

### SUMMARY

Disclosed is a production management device configured to monitor a state of a production device, the production device being configured to perform production with a change in a physical amount of a production environment by consuming a resource, the production management device includes: an environment change physical amount acquisition unit configured to acquire the physical amount of the production environment as an environment change physical amount, the physical amount of the production environment being changed by the production device consuming the resource; and a state determining unit configured to determine the state of the production device based on the environment change physical amount acquired by the environment change physical amount acquisition unit.

According to the configuration, the environment change physical amount that is acquired by exchanging the consumption resource in the production device is monitored, and the state determining unit is configured to determine the state of the production device based on the environment change physical amount acquired by the environment change physical amount acquisition unit.

Therefore, the state of the production device can be determined based on not whether the production device actually performs the production action to the work object, but the environment change physical amount exchanged with the consumed resource.

In the state determination, from the viewpoint of extracting the waste of the consumption resource, the state of the production device can properly be determined compared with the state determination based on the operation/non-operation of the production device.

The proper determination of the state of the production device can properly discriminate whether the resource consumed by the production device is the waste.

As described above, in the production management device of at least an embodiment of the present invention, irrespective of the operation/non-operation of the production device, advantageously the waste of the consumption resource may be correctly discriminated by properly determining the state of the production device.

The following production management system configured to include the production management device of the present invention is also included in the scope of the present invention. In accordance with at least an embodiment of the present invention, a production management system includes: a production device configured to perform production with a change in a physical amount of a production environment by consuming a resource; a production management device configured to monitor a state of the production device; and an environment change physical amount measurement unit configured to measure the physical amount, which is changed by the production device consuming the resource, as an environment change physical amount, wherein the production management device is configured to determine the state of the production device based on the environment change physical amount acquired by the environment change physical amount measurement unit.

A method of controlling a production management device configured to monitor a state of a production device, the production device being configured to perform production with a change in a physical amount of a production environment by consuming a resource, the method of controlling the production management device includes: an environment change physical amount acquisition step of acquiring the physical amount of the production environment as an environment change physical amount, the physical amount of the production environment being changed by the production device consuming the resource; and a state determination step of determining the state of the production device based on the environment change physical amount acquired in the environment change physical amount acquisition step.

The production management device may be constructed by a computer. In an embodiment, there is a computer-readable recording medium having stored thereon a control program including instructions which when executed on a computer, causes the computer to act as each unit of a production management device configured to monitor a state of a production device, the production device being configured to perform production with a change in a physical amount of a production environment by consuming a resource, the production management device includes:

an environment change physical amount acquisition unit configured to acquire the physical amount of the production environment as an environment change physical amount, the physical amount of the production environment being changed by the production device consuming the resource; and

a state determining unit configured to determine the state of the production device based on the environment change physical amount acquired by the environment change physical amount acquisition unit.

Accordingly, irrespective of the operation/non-operation of the production device, advantageously the waste of the consumption resource can be correctly discriminated by properly determining the state of the production device.

### BRIEF DESCRIPTION OF THE DRAWINGS

FIG. 1 is a block diagram illustrating a configuration of a main portion of a production management device according to an embodiment of the present invention.

FIG. 2 is a view illustrating an outline of a production management system of one embodiment of the present invention.

FIG. 3 is a view illustrating an example of a state determination condition stored in a condition storage unit of a production management device.

FIG. 4 is a view illustrating an example of a power discriminating condition stored in a condition storage unit of the production management device.

FIG. 5 is a flowchart illustrating a flow of state determination processing performed by a state determining unit of the production management device.

FIG. 6 is a flowchart illustrating a flow of power discriminating processing performed by a power discriminating unit of the production management device.

FIG. 7 is a flowchart illustrating a flow of another example of the power discriminating processing performed by the power discriminating unit of the production management device.

FIG. 8 is a view illustrating an example of a result graph generated by a result graph generating unit of the production management device.

FIG. 9 is a view illustrating an outline of a production management system according to another embodiment of the present invention.

FIGS. 10(a) and 10(b) are views illustrating an example of the state determination condition stored in the condition storage unit of the production management device of another embodiment.

FIG. 11 is a view illustrating an example of the power discriminating condition stored in the condition storage unit of the production management device.

FIG. 12A is a flowchart illustrating a flow of the state determination processing performed by the state determining unit of the production management device of another embodiment.

FIG. 12B is a flowchart illustrating a flow of the state determination processing performed by the state determining unit of the production management device of another embodiment.

FIG. 12C is a flowchart illustrating a flow of the state determination processing performed by the state determining unit of the production management device of another embodiment.

FIG. 13 is a flowchart illustrating a flow of the power discriminating processing performed by the power discriminating unit of the production management device of another embodiment.

FIG. 14 is a view illustrating an example of the result graph generated by the result graph generating unit of the production management device of another embodiment.

FIG. 15 is a graph illustrating a relationship between a fluctuation in monitored temperature and a threshold (management temperature) specifying a temperature proper range.

FIG. 16 is a view illustrating an example of the state determination condition stored in the condition storage unit of the production management device in a modification of the present invention.

FIG. 17 is a view illustrating an example of the power discriminating condition stored in the condition storage unit of the production management device in the modification of the present invention.

FIG. 18 is a flowchart illustrating a flow of the state determination processing performed by the state determining unit of the production management device and the power discriminating processing performed by the power discriminating unit in the modification of the present invention.

FIG. 19 is a view illustrating an outline of a production management system according to a modification of the present invention.

FIG. 20 is a view illustrating an example of the state determination condition stored in the condition storage unit of the production management device in the modification of the present invention.

FIG. 21 is a view illustrating an example of the power discriminating condition stored in the condition storage unit of the production management device in the modification of the present invention.

FIG. 22 is a view illustrating an outline of a production management system according to a modification of the present invention.

FIG. 23 is a view illustrating an example of the state determination condition stored in the condition storage unit of the production management device in the modification of the present invention.

FIG. 24 is a view illustrating an example of the power discriminating condition stored in the condition storage unit of the production management device in the modification of the present invention.

FIG. 25 is a view illustrating an example of the result graph generated by the result graph generating unit of the production management device in the modification of the present invention.

### DETAILED DESCRIPTION

### First Embodiment

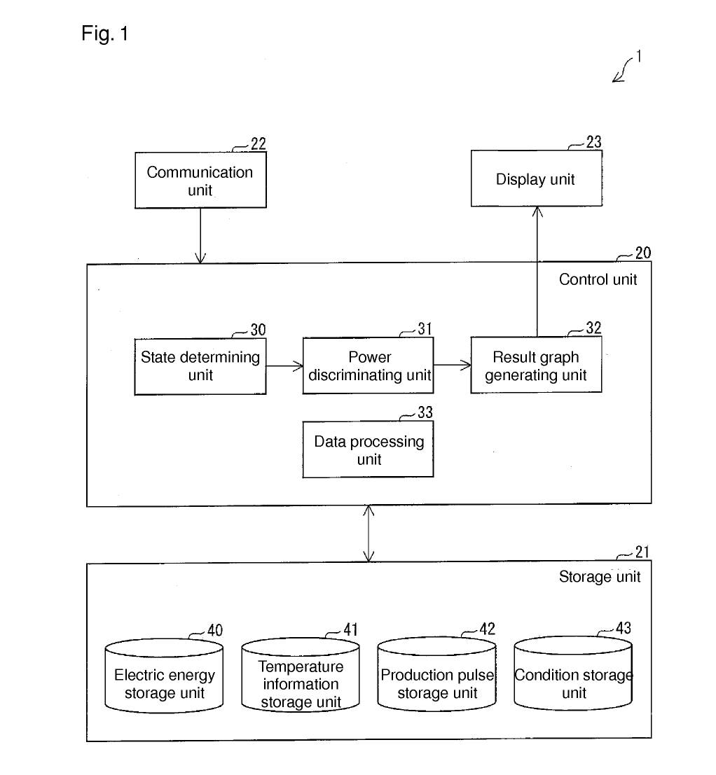

A first embodiment of the present invention will be described below with reference to FIGS. 1 to 8.

In the following embodiments, a production management device, which correctly discriminates a waste of a consumed power when a drying oven is the production device that consumes power (the resource and the consumed physical amount) to produce a product, and a production management system including the production management device are described by way of example.

In the following drawings, the same structural element is designated by the same symbol. Accordingly, the overlapping description of the already-described structural element is omitted in each embodiment.

[Outline of Production Management System]

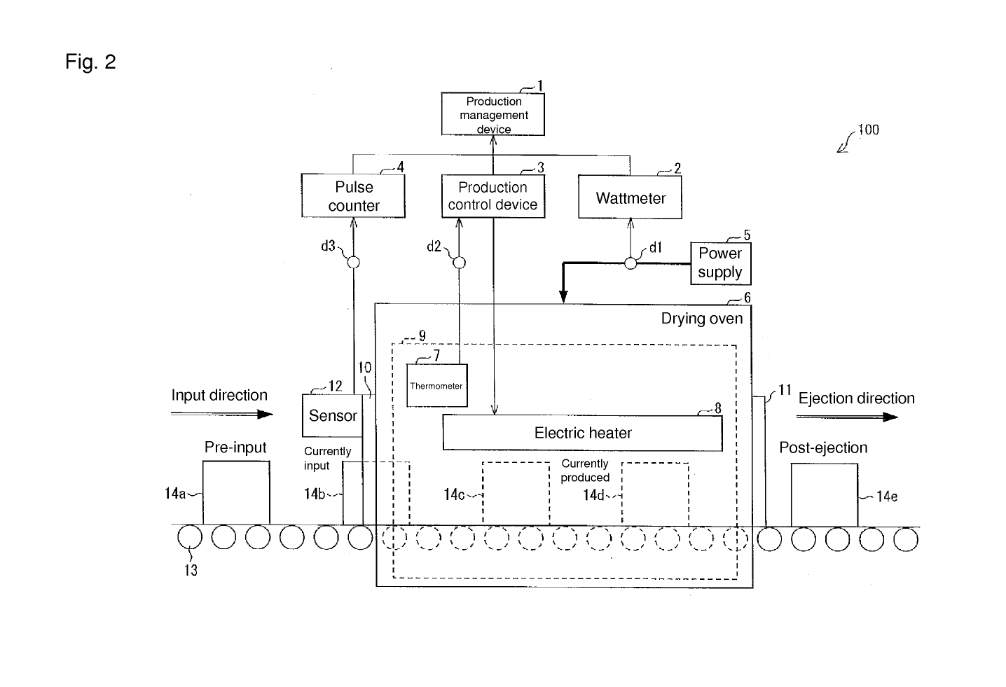

FIG. 2 is a view illustrating an outline of a production management system 100 of an embodiment of the present invention. As illustrated in FIG. 2, the production management system 100 includes a production management device 1, a wattmeter 2, a production control device 3, a pulse counter 4, a power supply 5, and a drying oven 6 which is the production device.

The drying oven 6 is a production facility that produces a product by drying a substance to be dried in the oven.

In the drying oven 6 of the present embodiment, an electric heater 8 is provided in a drying layer 9 made of a heat-resistant material and a heat insulating material, the drying layer 9 is raised to high temperature to remove moisture contained in the substance to be dried. However, the drying oven 6 is an example of the configuration of the drying oven 6, but does not restrict the configuration of the production device of the present invention. Although not illustrated, the drying layer 9 includes an intake port, an exhaust port, and a fan, and can efficiently discharge humid air filling the drying layer 9 without lowering the oven temperature (while the oven temperature is kept constant). Instead of the electric heater 8, a hot-air heater supplying hot air or warm air may be provided in the drying layer 9.

The drying oven 6 is connected to a roller conveyer 13, and a work piece 14 (14a to 14e) which is the substance to be dried is conveyed by the roller conveyer 13. The work pieces 14 are input to the drying layer 9 through an input port 10, take given time to pass through the drying layer 9, and are sequentially ejected from an ejection port 11 in a first-in first-out system.

In the example in FIG. 2, the work piece 14 takes the given time to be conveyed from the left to the right as indicated by a double arrow. The work piece 14a indicates the pre-input work piece, the work piece 14b indicates the work piece that is currently input to the drying layer 9, the work pieces 14c and 14d indicate the work pieces that are currently dried, namely, currently produced, and the work piece 14e indicates the post-ejection work piece. Thus, the work piece 14 takes the given time to pass through the drying layer 9 kept at constant temperature, which allows the moisture contained in the work piece 14 to be removed without damaging the work piece 14. The post-ejection work piece 14e is conveyed to a next production process or packed as a completed product.

A thermometer 7 is provided in the drying layer 9 to be able to monitor an oven temperature (the environment change physical amount). The thermometer 7 supplies an analog signal or a digital signal indicating sensed in-layer temperature information to the production control device 3 controlling the drying oven 6. The production control device 3 may include an analog input device. In the case that in-layer temperature information d2 is the analog signal, the analog input device performs A/D conversion of the analog signal, and the production control device 3 may supply data of the in-layer temperature information d2 to the production management device 1. Alternatively, the production management device 1 may include the analog input device to directly acquire the in-layer temperature information d2 from the thermometer 7. In the case that the in-layer temperature information d2 supplied from the thermometer 7 is the digital signal, the data of the in-layer temperature information d2 is directly supplied to the production management device 1 from the thermometer 7, or supplied to the production management device 1 from the thermometer 7 through the production control device 3.

The power supply 5 supplies the necessary power to the drying oven 6. In the present embodiment, the drying oven 6 converts the power into a heat quantity in order to maintain the drying layer 9 at high temperature. That is, the drying oven 6, consumes the consumption resource which is the “power”, to change the production environment or the “temperature”. A variation in production environment (in this case, a variation in temperature) may be expressed as the “environment change physical amount”. It is said that the drying oven 6 is the production device that consumes the consumption resource, acquires the environment change physical amount, and performs the production.

The wattmeter 2 measures power amount consumed by the drying oven 6. For example, the wattmeter 2 measures the consumed power of the drying oven 6 at predetermined time intervals (1 second, 10 seconds, 1 minute, . . . ). The wattmeter 2 supplies the acquired data (a consumed power d1) of the consumed power to the production management device 1.

The production control device 3 controls the drying oven 6. For example, the drying oven 6 is a Numeral Control Machine (NC machine). The production control device 3 transmits a numerical value indicating an objective temperature as an instruction signal to the drying oven 6, so that the drying oven 6 can perform the control to maintain the drying layer 9 at the objective temperature. The production control device 3 supplies the in-layer temperature information d2 acquired from the thermometer 7 to the production management device 1.

The pulse counter 4 conducts communication with a sensor 12 monitoring an operation of the drying oven 6, acquires a production pulse signal d3 output from the sensor 12, and supplies the production pulse signal d3 to the production management device 1.

For example, the sensor 12 is a photoelectric sensor, and is connected to the pulse counter 4 through an input terminal in a wired or wireless manner. For example, the sensor 12 is provided in the input port 10. In the case that the work piece 14 flowing on the roller conveyer 13 passes currently through the input port 10, the sensor 12 senses the passage of the work piece 14 and outputs an ON signal. In this case, one pulse from a time point at which an OFF signal is switched to the ON signal to a time point at which the ON signal is switched to the OFF signal can be acknowledged as the input of one work piece. The pulse counter 4 may count the pulse indicating the passage of the work piece 14 from the production pulse signal d3, calculate the number of input work pieces per unit time, and transmit the number of input work pieces to the production management device 1. Alternatively, the pulse counter 4 is incorporated in the production management device 1, and the production management device 1 may directly acquire the production pulse signal d3 from the sensor 12.

The wattmeter 2 and the pulse counter 4 may be constructed by one device that combines the functions of the wattmeter 2 and the pulse counter 4.

The configurations of the sensor 12 and the pulse counter 4 are not limited to the above configuration. Any well-known technology for monitoring the operation of the drying oven 6 may properly be adopted. For example, an IC tag is buried in the work piece 14, a tag reader provided in the input port 10 may read the work piece 14 when the work piece 14 passes through the input port 10. In this case, when the production pulse signal d3 that can be acknowledged as the pulse at the time point at which the tag reader reads the IC tag is supplied to the pulse counter 4 from the tag reader, the number of work pieces 14 passing through the input port 10 can be counted. Alternatively, the number of work pieces 14 passing through the input port 10 can be counted even in a configuration in which a barcode attached to the work piece 14 is read.

The production management device 1, the wattmeter 2, the production control device 3, and the pulse counter 4 are communicably connected to one another through wired or wireless communication means.

From the viewpoint of extracting the waste of the consumption resource (the power), the production management device 1 of the present invention can determine the operation of the drying oven 6 in consideration of the environment change physical amount (the in-layer temperature information d2). Hereinafter, the processing (the function) performed by the production management device 1 is referred to as state determination processing (function). Also the production management device 1 can more correctly perform the state determination processing of the drying oven 6 using the production pulse signal d3 supplied from the pulse counter 4 in addition to the in-layer temperature information d2.

Additionally, the production management device 1 can sort the consumed physical amount (the consumed power d1) supplied from the wattmeter 2 according to a result of the state determination processing. That is, the consumed power (the resource) of the production device (the drying oven 6) can be sorted from the viewpoint of whether the consumed power is the waste. Hereinafter, the processing (the function) performed by the production management device 1 is referred to as power discriminating processing (function).

A configuration of the production management device 1 including the state determination function and the power discriminating function will be described in detail below.

[Configuration of Production Management Device]

FIG. 1 is a block diagram illustrating a configuration of a main portion of the production management device 1 of an embodiment of the present invention. As illustrated in FIG. 1, the production management device 1 of the present embodiment includes a control unit 20, a storage unit 21, a communication unit 22, and a display unit 23. Although not illustrated, the production management device 1 may include an operation unit to which a user inputs the instruction signal to the production management device 1. The operation unit is constructed by such a proper input device as a keyboard, a mouse, a button (a cross-key, a decision key, a character input key, and the like), a touch panel, a touch sensor, and a stylus.

The communication unit 22 conducts communication with an external device. For example, the communication unit 22 transmits and receives data to and from the devices (the wattmeter 2, the production control device 3, and the pulse counter 4) of the local production management system 100 through a LAN. Alternatively, the production management device 1 may be connected to the wattmeter 2, the production control device 3, and the pulse counter 4 in the wired or wireless manner on a one-on-one basis. In this case, the communication unit 22 is configured to be able to identify the wattmeter 2, the production control device 3, and the pulse counter 4 to understand which device currently conducts communication therewith.

The display unit 23 displays an analysis result that the production management device 1 obtains by analyzing the externally-acquired data. The result of the state determination processing performed by the production management device 1 and the result of the power discriminating processing performed by the production management device 1 can be plotted to be displayed an example of the analysis result. For example, the display unit 23 is constructed by such a proper display device as an LCD (Liquid Crystal Display).

(1) A control program performed by the control unit 20, (2) an OS program, (3) an application program used by the control unit 20 to perform various functions included in the production management device 1, and (4) various pieces of data read to perform the application program are stored in the storage unit 21. Particularly, various programs and the pieces of data, which are read when the production management device 1 performs the state determination function and the power discriminating function, are stored in the storage unit 21. Specifically, the storage unit 21 includes an electric energy storage unit 40, a temperature information storage unit 41, a production pulse storage unit 42, and a condition storage unit 43. Although not illustrated, the storage unit 21 may include a result storage unit in which a result graph obtained by the production management device 1 as a result of the performance of the state determination processing or power discriminating processing is stored.

The production management device 1 also includes a temporary storage unit (not illustrated). The temporary storage unit is what is called a working memory, such as a RAM (Random Access Memory), in which the data used in calculation and a calculation result are temporarily stored in the process of various pieces of processing performed by the production management device 1.

The control unit 20 wholly controls each unit included in the production management device 1, and the control unit 20 includes at least a state determining unit 30, a power discriminating unit 31, and a result graph generating unit 32 as a functional block. The control unit 20 may further include a data processing unit 33.

Each functional block of the control unit 20 is implemented such that a CPU (Central Processing Unit) reads the program, which is stored in a storage device (the storage unit 21) constructed by a ROM (Read Only Memory), an NVRAM (Non-Volatile Random Access Memory), and the like, on a temporary storage unit (not illustrated, the RAM and the like) and executes the program.

The consumed power d1 acquired from the wattmeter 2 by the communication unit 22 is stored in the electric energy storage unit 40. The wattmeter 2 measures the consumed power amount of the drying oven 6 at predetermined time intervals. For the consumed power amount of the drying oven 6, the consumed power amount per unit time along time passage is stored in the electric energy storage unit 40 together with information on a clock time when the power is consumed.

The consumed power amount may be stored at time intervals different from those of the wattmeter 2. For example, the consumed power measured by the wattmeter 2 at intervals of one second is accumulated at intervals of one minute, and the consumed power amount may be stored per minute.

The in-layer temperature information d2 acquired from the thermometer 7 (the production control device 3) by the communication unit 22 is stored in the temperature information storage unit 41. The sensed temperature may be accumulated in real time in the temperature information storage unit 41 together with information on the clock time sensed by the thermometer 7. Alternatively, the temperature accumulated in real time is divided into regular time intervals and an average value of the temperature calculated in each zone may be accumulated. Alternatively, the temperature sensed by the thermometer 7 at regular time intervals may be accumulated.

The production pulse signal d3 acquired from the pulse counter 4 by the communication unit 22 is stored in the production pulse storage unit 42. Together with the time passage, a sensing signal output from the sensor 12 may directly be accumulated in the production pulse storage unit 42. Alternatively, the result (for example, “the number of input work pieces” per unit time) in which the pulse counter 4 analyzes the production pulse signal d3 may be accumulated in the production pulse storage unit 42. The production pulse signal d3 output from the sensor 12 is directly stored in the production pulse storage unit 42, and the pulse may be analyzed (counted) in the production management device 1.

A determination (the discrimination) condition is stored in the condition storage unit 43 in order that the production management device 1 performs the state determination processing or the power discriminating processing. The production management device 1 can determine the state of the drying oven 6 or sort the power by referring to the condition stored in the condition storage unit 43.

The state determining unit 30 performs the state determination processing of the production management device 1. In the present embodiment, specifically, the operating state of the drying oven 6 is determined from the viewpoint of extracting the waste of the power based on the in-layer temperature information d2 stored in the temperature information storage unit 41. In the present embodiment, the state determining unit 30 may determine the state of the drying oven 6 by referring to the production pulse signal d3 stored in the production pulse storage unit 42 in addition to the in-layer temperature information d2. More particularly, according to the determination condition stored in the condition storage unit 43, the state determining unit 30 determines the state of the drying oven 6 based on the temperature in the layer of the drying oven 6 and the number of input work pieces per unit time.

The power discriminating unit 31 performs the power discriminating processing of the production management device 1. In the present embodiment, specifically, the power discriminating unit 31 discriminates whether the consumed power per unit time of the drying oven 6, which is accumulated in the electric energy storage unit 40, is the wasted power. The power discriminating unit 31 can discriminate whether the power consumed by the drying oven 6 is the waste at different times according to the state of the drying oven 6, which is determined by the state determining unit 30. As used herein, the unwasted (necessary) consumed power means the power that is consumed by the drying oven 6 when the drying oven 6 performs the operation contributing to production activity for the work piece 14. The wasted consumed power means the power that is consumed by the drying oven 6 when the drying oven 6 does not perform the operation contributing to the production activity.

From the viewpoint of whether the power is the waste, the power discriminating unit 31 discriminates the consumed power of the drying oven 6 based on the state of the drying oven 6, which is determined by the state determining unit 30 according to the discriminating condition stored in the condition storage unit 43.

The result graph generating unit 32 generates a result graph expressing the result of the state determination processing performed by the state determining unit 30, the result of the power discriminating processing performed by the power discriminating unit 31, or the both. The result graph generated by the result graph generating unit 32 is output to the display unit 23.

The user can easily check what the state of the drying oven 6 is in what time period by checking the result graph of the state determination processing displayed on the display unit 23. Additionally, by checking the result graph of the power discriminating processing, the user can easily sort whether the consumed power is the waste while checking how much the power is consumed in what time period.

The data processing unit 33 processes various pieces of data (such as the consumed power d1, the in-layer temperature information d2, and the production pulse signal d3) acquired from the outside of the production management device 1 or various pieces of data stored in the storage units of the storage unit 21.

As described above, the data processing unit 33 may accumulate and store the consumed power amount at time intervals different from those of the wattmeter 2. The data processing unit 33 may calculate a temperature average value at regular time intervals from the temperature information sensed by the thermometer 7, and extract the temperature information at regular time intervals. The data processing unit 33 may calculate the number of input work pieces per unit time based on the number of pulses counted by the pulse counter 4. Alternatively, the data processing unit 33 may analyze the production pulse signal d3 to count the number of pulses.

These pieces of data processing may be performed according to a user instruction input from the operation unit (not illustrated) or the previously-stored application program.

[State Determination Condition]

FIG. 3 is a view illustrating an example of the state determination condition stored in the condition storage unit 43.

As illustrated in FIG. 3, in the present embodiment, the state determination condition has the following data structure. The conceivable state of the drying oven 6 is stored while correlated with each of a combination of a condition of the temperature in the drying layer 9 of the drying oven 6 in a predetermined time period and a condition of the number of input work pieces in the same time period. FIG. 3 illustrates the data structure of the state determination condition by way of example, but the present invention is not limited to the data structure of the state determination condition in FIG. 3.

In the example in FIG. 3, the proper temperature in the drying layer 9 is previously set to a range of 180 to 200° C. in order to produce the work piece in the production management system 100.

Therefore, according to the state determination condition in FIG. 3, the state determining unit 30 can determine the state of the drying oven 6 based on the temperature in the layer of the drying oven 6 and the number of input work pieces per unit time.

More specifically, the state determining unit 30 acquires the in-layer temperature information d2 measured in a predetermined time period (for example, 9:00 to 9:10) from the temperature information storage unit 41. The state determining unit 30 acquires the number of input work pieces in the same time period from the production pulse storage unit 42.

At this point, for example, in the case that the number of input work pieces is zero (pieces/min) while the acquired temperature information is 170° C. (less than 180° C.), according to the state determination condition in FIG. 3, the state determining unit 30 determines that the drying oven 6 in the time period of 9:00 to 9:10 is in the state of “0: start-up”.

The state of “0: start-up” means the state from when (the electric heater 8 of) the drying oven 6 operates to when the temperature in the drying layer 9 reaches from room temperature to the production proper temperature (180° C.). Although the drying oven 6 operates in the state of “0: start-up”, the drying oven 6 does not reach the production proper temperature. Therefore, the work piece cannot be input. However, the state of “0: start-up” is for the drying oven 6 to reach the production proper temperature (180° C.).

On the other hand, in the case that the number of input work pieces is zero (pieces/min) while the acquired temperature information is the production proper temperature (180 to 200° C.), the state determining unit 30 determines that the drying oven 6 in the time period is the state of “1: normal standby”. Because the drying layer 9 reaches the production proper temperature, the drying oven 6 in the state of “1: normal standby” is in the state in which the work piece is not input (not produced) although the production activity can be performed. The state in which the work piece is not produced although the drying oven 6 can produce the work piece is preferably shortened from the viewpoints of both the production efficiency and the wasted power.

In the case that the number of input work pieces is greater than zero while the acquired temperature information is the production proper temperature, the state determining unit 30 determines that the drying oven 6 in the time period is the state of “4: normal production”. In the state of “4: normal production”, the drying oven 6 normally produces the work piece 14 while the drying layer 9 is maintained at the production proper temperature.

On the other hand, in the case that the work piece 14 is produced at temperature less than a lower limit of 180° C. of the drying layer 9 or temperature greater than an upper limit of 200° C., the state determining unit 30 determines that the drying oven 6 is in the state of “3: abnormal production” or “5: abnormal production”. When the state determining unit 30 determines that the drying oven 6 is in the state of “abnormal production”, the work piece 14 produced by the drying oven 6 is discarded as a reject. Accordingly, the state of “abnormal production” is preferably brought close to zero as much as possible from the viewpoints of both the production efficiency and the wasted power (and other resources).

In the case that the number of input work pieces is zero while the temperature of the drying layer 9 is greater than the upper limit of 200° C., the state determining unit 30 determines that the drying oven 6 is in the state of “2: abnormal standby”. In the state of “2: abnormal standby”, because the work piece 14 is not input to the drying oven 6, the reject is not generated, but the temperature in the drying layer 9 is greater than or equal to the production proper temperature. Therefore, it is considered that the state of “2: abnormal standby” is the state in which the resource (the power) is consumed beyond necessity.

Thus, the state determining unit 30 acquires the temperature information and the number of input work pieces at regular time intervals to perform the state determination processing of the drying oven 6. The state determining unit 30 outputs the state determination processing result (one of the states “0” to “5”), which are determined based on the temperature information and the number of input work pieces, to the power discriminating unit 31.

[Power Discriminating Condition]

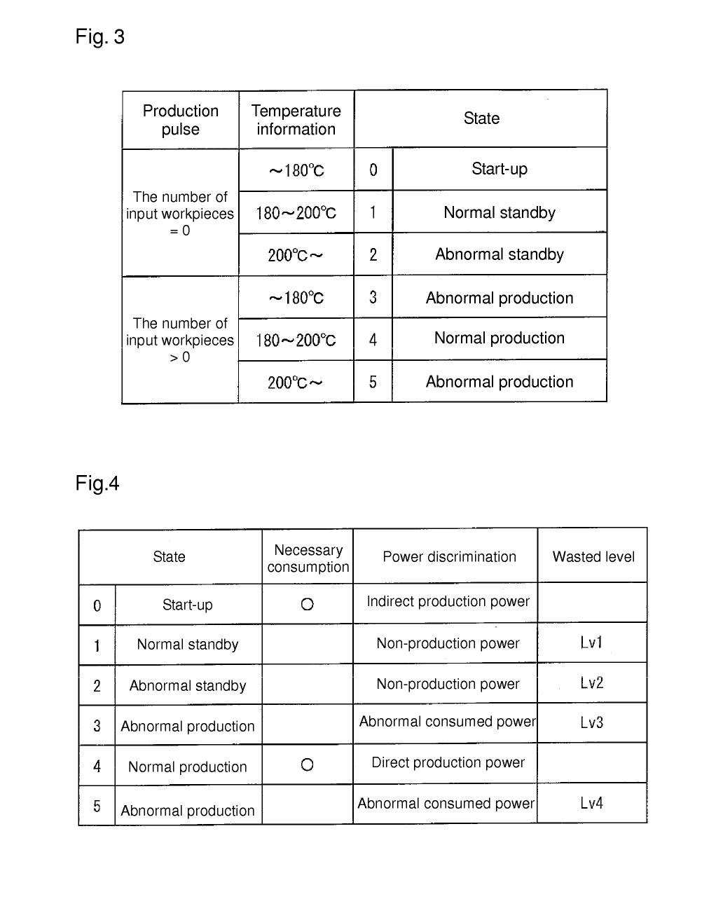

FIG. 4 is a view illustrating an example of the power discriminating condition stored in the condition storage unit 43.

As illustrated in FIG. 4, in the present embodiment, the power discriminating condition has the following data structure. A flag indicating whether the power consumed in each of the conceivable states (determined by the state determining unit 30) in the drying oven 6 is the waste is stored while correlated with each state. A label indicating a grade of the power consumed in the state is also stored while correlated with each state. An index (a wasted level) indicating how much waste is stored while correlated with an item (in the example in FIG. 4, the states “1”, “2”, “3”, and “5”) that is classified as the unnecessary consumption. FIG. 4 illustrates the data structure of the power discriminating condition by way of example, but the present invention is not limited to the data structure of the power discriminating condition in FIG. 4.

Therefore, according to the power discriminating condition in FIG. 4, the power discriminating unit 31 can discriminate the waste of the consumed power in the drying oven 6 based on the state of the drying oven 6, which is determined by the state determining unit 30.

More specifically, in the flag of the necessary consumption, “0” expresses the necessary power (not wasted), and therefore a blank expresses the wasted power. The power discriminating unit 31 discriminates that the power, which is consumed when the drying oven 6 is in the state of “0: start-up”, is not wasted.

As described above, the state of “0: start-up” of the drying oven 6 is the state (the process) for the drying oven 6 to reach the production proper temperature (180° C.). According to the power discriminating condition, the power discriminating unit 31 can discriminate that the power in the start-up state is not wasted even if the drying oven 6 is in the non-production state.

Because the state of “4: normal production” of the drying oven 6 contributes directly to the production, the power discriminating unit 31 can discriminate that the consumed power in the state of “4: normal production” is not wasted.

The power discriminating unit 31 can discriminate that the power consumed in the state except the state of “4: normal production” is wasted.

The power discriminating label is added in order to further segment and sort the power consumed by the drying oven 6 from the viewpoint of extracting the waste.

As described above, the state of “0: start-up” is the process for the production although the state of “0: start-up” does not directly contribute to the production. The power consumed in the state of “0: start-up” is discriminated as an “indirect production power” with the grade in which the power contributes indirectly to the production.

The state of “4: normal production” is the state in which the production is performed at the production proper temperature (180 to 200° C.) to normally eject the work piece 14. The power consumed in the state of “4: normal production” is discriminated as a “direct production power” with the grade in which the power contributes directly to the production.

The states of “1: normal standby” and “2: abnormal standby” are the states in which the production is not performed although the drying oven 6 reaches the temperature greater than or equal to the production proper temperature (180° C.). The powers consumed in the states of “1: normal standby” and “2: abnormal standby” are discriminated as a “non-production power” with the grade in which the power does not directly or indirectly contribute to the production but is uselessly consumed.

The states of “3: abnormal production” and “5: abnormal production” are the states in which the reject is ejected because the production is performed at the temperature except the production proper temperature (180 to 200° C.). The powers consumed in the states of “3: abnormal production” and “5: abnormal production” are discriminated as an “abnormal consumed power” with the grade in which not only the power does not contribute to the production but also the power takes part in a loss that the reject is ejected.

It is considered that, in the states “2” and “5”, the temperature in the drying layer 9 exceeds 200° C. to consume the excess power compared with the states “1” and “3”. It is also considered that the losses in the states “3” and “5” in which the reject are ejected are larger than the losses in states “1” and “2”.

Therefore, the wasted level of the consumed power in the state of “1: normal standby” may be set to “Lv1”, and the wasted level in the state of “2: abnormal standby” may be set to “Lv2” higher than that of the state of “1: normal standby”. The wasted level of in the state of “3: abnormal production” may be set to “Lv3” higher than that of the states of “1: normal standby” and “2: abnormal standby”, and the wasted level in the state of “5: abnormal production” may be set to the highest “Lv4”.

Thus, the power discriminating unit 31 discriminates the grade of the consumed power at regular time intervals based on the determined state of the drying oven 6. The power discriminating unit 31 outputs the power discriminating processing result (such as the flag indicating whether the power is the waste, the label, and the wasted level) to the result graph generating unit 32.

[State Determination Processing Flow]

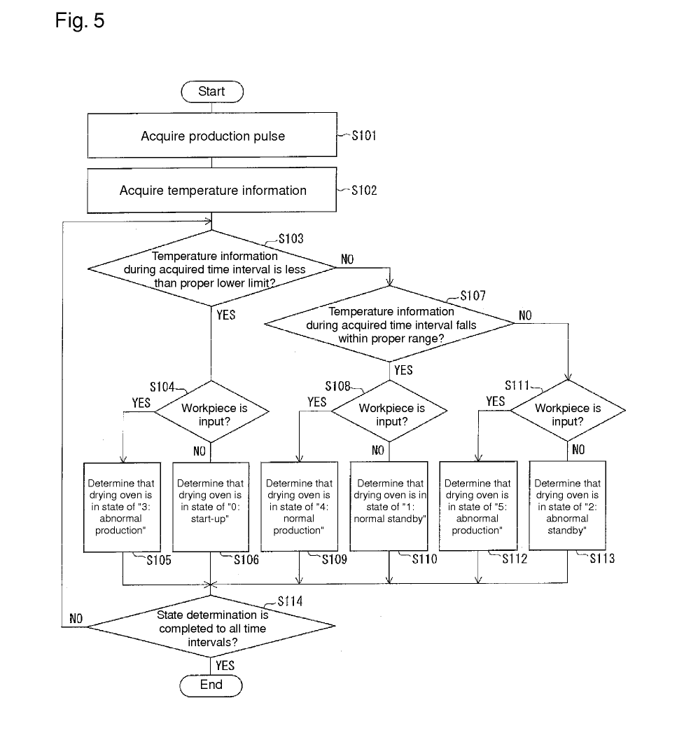

FIG. 5 is a flowchart illustrating a flow of the state determination processing performed by the state determining unit 30.

The state determining unit 30 acquires the production pulse signal d3 (or the number of work piece inputs) from the production pulse storage unit 42, and acquires the in-layer temperature information d2 (hereinafter referred to as temperature information) from the temperature information storage unit 41 (S101 and S102). At this point, it is assumed that the acquired pieces of data of the number of input work pieces and temperature information are pieces of data indicating transitions of the number of input work pieces and temperature information during a period of 9:00 to 15:00 on a certain day.

In the present embodiment, the state determining unit 30 divides the time period of 9:00 to 15:00 into regular time intervals (for example, every 10 minutes), and makes the state determination of the drying oven 6 during each divided time interval. According to the state determination condition in FIG. 3, the state determining unit 30 makes the determination as follows.

The state determining unit 30 determines whether the temperature information during the acquired time interval (for example, 9:00 to 9:10) is less than the proper lower limit (for example, 180° C.) (S103).

When the temperature in the drying layer 9 is less than the proper lower limit (Yes in S103), the state determining unit 30 determines whether the number of input work pieces during the same time interval (the time period) is greater than zero (S104). When the number of input work pieces is greater than zero, namely, when the work piece is input in the time period (YES in S104), the state determining unit 30 determines that the drying oven 6 in the time period (9:00 to 9:10) is in the state of “3: abnormal production” (S105). On the other hand, when the number of input work pieces is zero, namely, when the work piece is not input in the time period (NO in S104), the state determining unit 30 determines that the drying oven 6 in the time period is in the state of “0: start-up” (S106).

On the other hand, when the temperature in the drying layer 9 is greater than or equal to the proper lower limit (NO in S103), the state determining unit 30 determines whether the temperature information during the time interval falls within the production proper range (180 to 200° C.) (S107).

When the temperature in the drying layer 9 falls within the proper range (YES in S107), the state determining unit 30 determines whether the number of input work pieces during the time interval is zero or greater than zero (S108). When the work piece is input (YES in S108), the state determining unit 30 determines that the drying oven 6 during the time interval (9:00 to 9:10) is in the state of “4: normal production” (S109). On the other hand, when the work piece is not input in the time period (NO in S108), the state determining unit 30 determines that the drying oven 6 during the time interval is in the state of “1: normal standby” (S110).

On the other hand, when the temperature in the drying layer 9 is out of the proper range, namely, when the oven temperature is greater than the proper upper limit (200° C.) (NO in S107), the state determining unit 30 determines whether the number of input work pieces during the time interval is zero or greater than zero (S111). When the work piece is input (YES in S111), the state determining unit 30 determines that the drying oven 6 during the time interval (9:00 to 9:10) is in the state of “5: abnormal production” (S112). On the other hand, when the work piece is not input in the time period (NO in S111), the state determining unit 30 determines that the drying oven 6 during the time interval is in the state of “2: abnormal standby” (S113).

When the time interval during which the state determination is not made yet remains after one of the states “0” to “5” is determined with respect to the time interval (NO in S114), the temperature information on the next time interval (for example, 9:10 to 9:20) and the number of input work pieces are acquired to repeat the pieces of processing in S103 to S113.

When the state determination is made to all the time intervals (9:00 to 15:00) (YES in S114), the state determining unit 30 outputs the state determination processing results of all the time intervals to the power discriminating unit 31 to end the state determination processing.

[Power Discriminating Processing Flow]

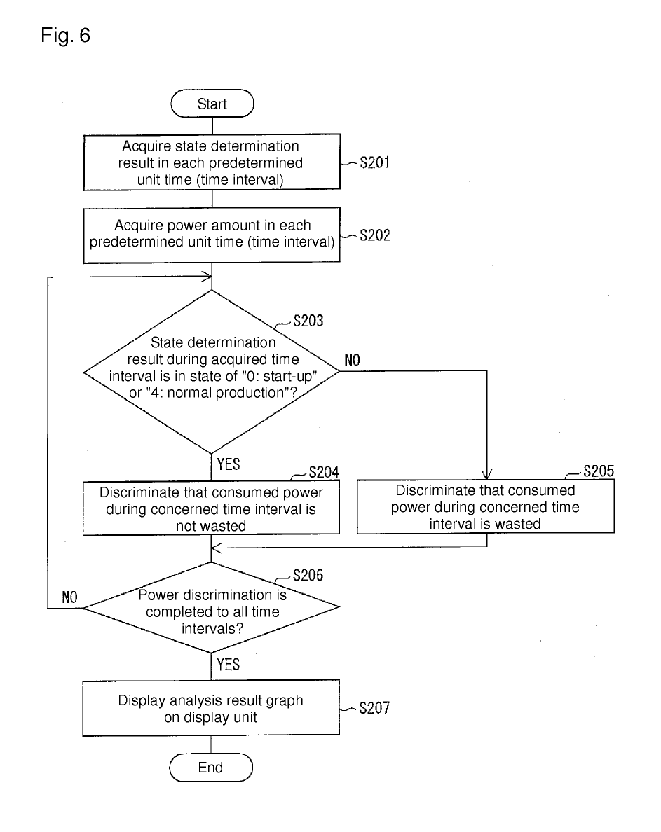

FIG. 6 is a flowchart illustrating a flow of the power discriminating processing performed by the power discriminating unit 31.

The power discriminating unit 31 acquires the state determination processing results of all the time intervals, which are output from the state determining unit 30, in each time interval (S201). The power discriminating unit 31 acquires the consumed power d1 from the electric energy storage unit 40 (S202). At this point, in the case that the state determining unit 30 makes the state determination at time intervals of 10 minutes, preferably the consumed power amount is acquired while accumulated every 10 minutes.

In the example in FIG. 6, the power discriminating unit 31 discriminates the waste of the consumed power according to the flag of the necessary consumption in the power discriminating conditions in FIG. 4.

When the drying oven 6 during the acquired time interval is in the state of “0: start-up” or “4: normal production” (YES in S203), the power discriminating unit 31 discriminates the consumed power during the time interval as the necessary consumed power (not wasted) according to the power discriminating condition (S204). On the other hand, when the drying oven 6 during the acquired time interval is in one of the states of “1” to “3” and “5” (NO in S203), the power discriminating unit 31 discriminates the consumed power during the time interval as the wasted consumed power (S205).

When the time interval during which the power discrimination is not performed yet remains after the power discrimination is performed to the time interval (NO in S206), the state determination processing result during the next time interval (for example, 9:10 to 9:20) is acquired to repeat the pieces of processing in S203 to S205.

When the power discrimination is performed to all the time intervals (9:00 to 15:00) (YES in S206), the power discriminating unit 31 outputs the power discriminating processing results of all the time intervals to the result graph generating unit 32. Based on the power discriminating processing result output from the power discriminating unit 31, the result graph generating unit 32 generates the result graph, and displays the result graph on the display unit 23 (S207). Then the power discriminating processing is ended.

[Power Discriminating Processing Flow]

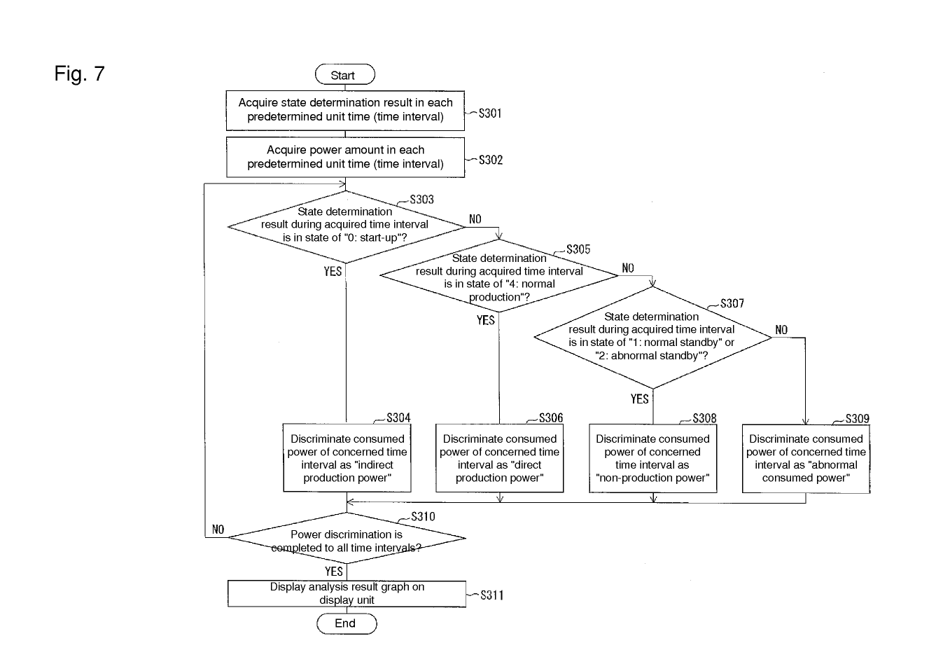

FIG. 7 is a flowchart illustrating a flow of another piece of power discriminating processing performed by the power discriminating unit 31.

Like FIG. 6, the power discriminating unit 31 acquires the state determination processing results of all the time intervals from the state determining unit 30 in each time interval (S301), and the power discriminating unit 31 acquires the consumed power amounts of all the time intervals from the electric energy storage unit 40 in each time interval (S302).

In the example in FIG. 7, the power discriminating unit 31 discriminates the grade of the consumed power according to the label of the power discrimination in the power discriminating conditions in FIG. 4.

When the drying oven 6 during the acquired time interval is in the state of “0: start-up” (YES in S303), the power discriminating unit 31 discriminates the consumed power during the time interval as the “indirect production power” according to the power discriminating condition (S304). When the drying oven 6 is in the state of “4: normal production” (NO in S303 and YES in S305), the power discriminating unit 31 discriminates the consumed power during the time interval as the “direct production power” (S306). When the drying oven 6 is in the state of “1: normal standby” or “2: abnormal standby” (NO in S303, NO in S305, and YES in S307), the power discriminating unit 31 discriminates the consumed power during the time interval as the “non-production power” (S308). When the drying oven 6 is in the state of “3: abnormal production” or “5: abnormal production” (NO in S303, NO in S305, and NO in S307), the power discriminating unit 31 discriminates the consumed power during the time interval as the “abnormal consumed power” (S309).

When the time interval during which the power discrimination is not performed yet remains after the power discrimination is performed to the time interval (NO in S310), the state determination processing result during the next time interval (for example, 9:10 to 9:20) is acquired to repeat the pieces of processing in S303 to S309.

When the power discrimination is performed to all the time intervals (9:00 to 15:00) (YES in S310), the power discriminating unit 31 outputs the power discriminating processing results of all the time intervals to the result graph generating unit 32. Based on the power discriminating processing result output from the power discriminating unit 31, the result graph generating unit 32 generates the result graph, and displays the result graph on the display unit 23 (S311). Then the power discriminating processing is ended.

In the power discriminating processing, from the viewpoint of discriminating the waste of the consumed power, the consumed power can correctly be discriminated according to the state of the drying oven 6 while the power discriminating processing result can easily be presented to the user.

[Result Graph]

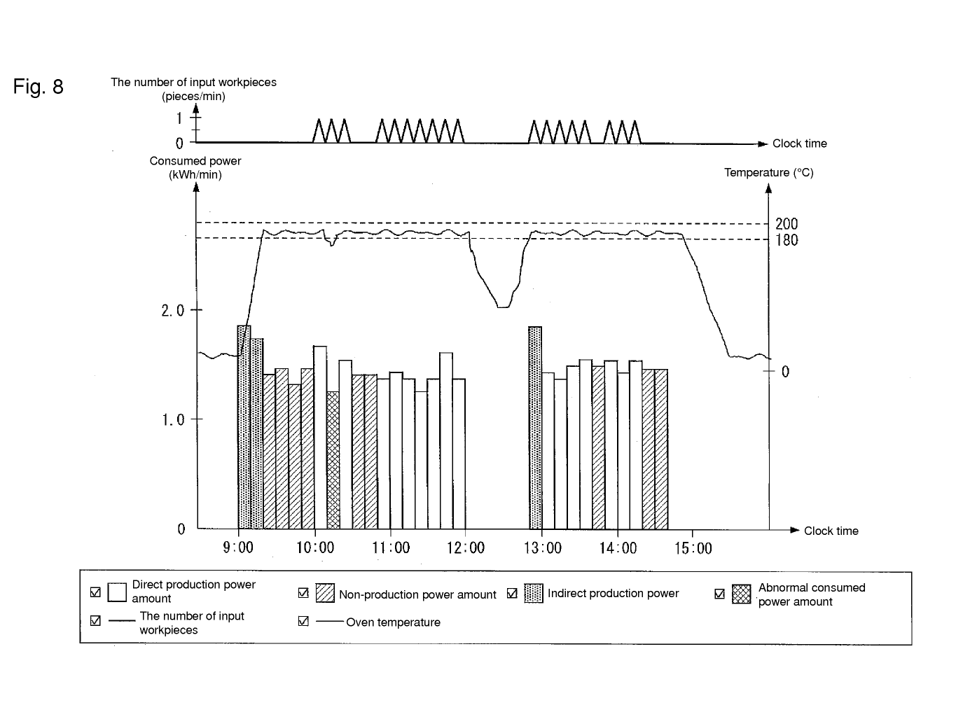

FIG. 8 is a view illustrating an example of the result graph generated by the result graph generating unit 32. The result graph is output from the result graph generating unit 32 and displayed on the display unit 23.

In the example in FIG. 8, but not limited to, two two-dimensional graphs are vertically displayed. The upper graph that is of reference information is a graph that expresses the transition of the number of input work pieces based on the production pulse signal d3. The lower graph is a graph (a bar graph) expresses the transition of the consumed power amount of the drying oven 6 and the discrimination result of the consumed power. A graph (a line graph) indicating the transition of the temperature in the drying layer 9 may be plotted in the lower graph.

In both the upper and lower graphs, a horizontal axis expresses a clock time. Preferably a display interval of the clock time is common to all the graphs. Therefore, the passage of the clock time and the transitions of all the values along the passage can be checked at a glance to improve convenience of the user.

In the upper graph, a vertical axis expresses the number of input work pieces per one minute. In the upper graph, the time periods (10:00 to 10:30, 10:50 to 12:00, 12:50 to 13:40, and 13:50 to 14:20) in which the number of input work pieces is greater than zero are the time periods in which the drying oven 6 performs the production activity.

In the lower graph, the vertical axis expresses the temperature (° C.) in the drying layer 9 and the consumed power amount (kWh/min).

In the bar graph, one bar expresses the accumulated consumed power amount for ten minutes. For example, the bar corresponding to the time period of 9:00 to 9:10 is color-coded, which allows the user to understand that the consumed power of about 1.8 kWh/min consumed in the time period is labeled as the “indirect production power”. The state determination processing results may be plotted. Therefore, the user can understand that the drying oven 6 is in the state of “0: start-up” in the time period of 9:00 to 9:10.

In another time interval (10:10 to 10:20), the temperature in the drying layer 9 does not reach the proper temperature although the work piece is input. The bar graph during the time interval (10:10 to 10:20) is color-coded as so to indicate the “abnormal consumed power”.

Thus, the user can check the state of the drying oven 6 during all the time intervals (9:00 to 15:00) and the consumed power discrimination result of the drying oven 6 at a glance by displaying the result graph on the display unit 23.

### Second Embodiment

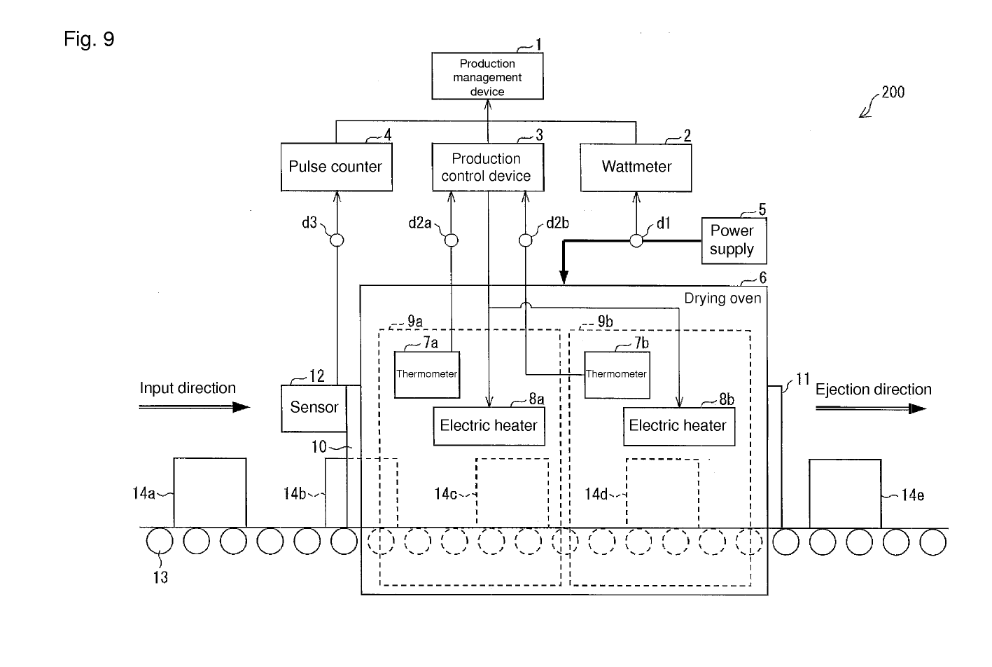

Another embodiment of the present invention will be described below with reference to FIGS. 9 to 14.

In the present embodiment, the drying oven 6 includes a plurality of drying layers 9 having different production proper temperatures. The state determination function and power discriminating function of the production management device 1, which correspond to those of the above embodiment, will be described below.

[Outline of Production Management System]

FIG. 9 is a view illustrating an outline of a production management system 200 of an embodiment of the present invention. The production management system 200 of the present embodiment differs from the production management system 100 (FIG. 2) of the first embodiment in that the drying oven 6 includes drying layer 9a and a drying layer 9b, which have the production proper temperatures different from each other.

Therefore, the thermometer is provided in each drying layer 9. A thermometer 7a measures the temperature at the drying layer 9a, and outputs first in-layer temperature information d2a which is data of the measurement result to the production control device 3. A thermometer 7b measures the temperature at the drying layer 9b, and outputs second in-layer temperature information d2b to the production control device 3.

In the present embodiment, by way of example, it is assumed that the production proper temperature of the drying layer 9a is previously set to 180 to 200° C., and that the proper production temperature of the drying layer 9b is previously set to 120 to 130° C.

[State Determination Condition]

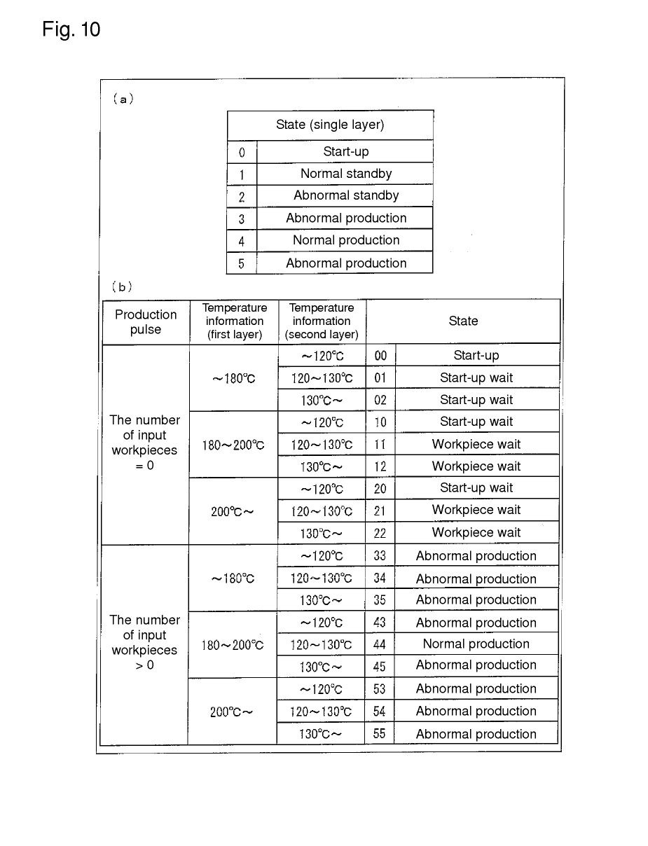

FIGS. 10(a) and 10(b) are views illustrating an example of the state determination condition stored in the condition storage unit 43 of the present embodiment.

As illustrated in FIG. 10(b), in the present embodiment, the state determination condition has the following data structure. The conceivable state of the drying oven 6 is stored while correlated with each of the combination of the condition of the number of input work pieces, a condition of a first temperature in the drying layer 9a, and a condition of a second temperature in the drying layer 9b. FIG. 10 illustrates the data structure of the state determination condition by way of example, but the present invention is not limited to the data structure of the state determination condition in FIG. 10.

According to the state determination condition in FIG. 10(b), for example, in the case that the number of input work pieces is zero in a certain time interval while the drying layers 9a and 9b have the temperatures of 170° C. and 125° C., respectively, the drying layer 9b waits until the drying layer 9a becomes the proper temperature, so that the state determining unit 30 can determine that the drying oven 6 is in the whole state of “01: wait for start-up”.

That is, the state determining unit 30 is configured to determine that the drying oven 6 is in the state of “start-up wait” when only one of the drying layers 9 does not reach the proper temperature while the work piece is not input, and the conditions are set in that manner. The state determining unit 30 is configured to determine that the drying oven 6 is in the state of “work piece wait” when both the drying layers 9 is greater than or equal to the proper temperature, and the conditions are set in that manner.

On the other hand, the state determining unit 30 is configured to determine that the drying oven 6 is in the state of “abnormal production” when at least one of the drying layers 9 is out of the proper temperature while the work piece is input, and the conditions are set in that manner. The state determining unit 30 is configured to determine that the drying oven 6 is in the state of “normal production” only when both the drying layers 9 fall within the proper temperature, and the conditions are set in that manner.

The configuration of the production management device 1 of the present embodiment is also expressed as follows.

That is, the state determining unit 30 is configured to determine the state of each single layer and to determine the whole state of the drying oven 6 by the combination of the states of the single layers.

Like the first embodiment, the state determining unit 30 refers to the state determination condition in FIG. 10(a) to make the state determination of each single layer. Based on the combination of the states of the two layers, the state determining unit 30 can determine the whole state of the drying oven 6 corresponding to the combination.

For example, in the same procedure as the first embodiment, it is assumed that the state determining unit 30 determines that the first drying layer 9a is in the state of 0: start-up” and determines that the second drying layer 9b is in the state of “1: normal standby”. In this case, the determination that the whole drying oven 6 is in the state of “01: start-up” is made by the combination of “0” and “1”.

[Power Discriminating Condition]

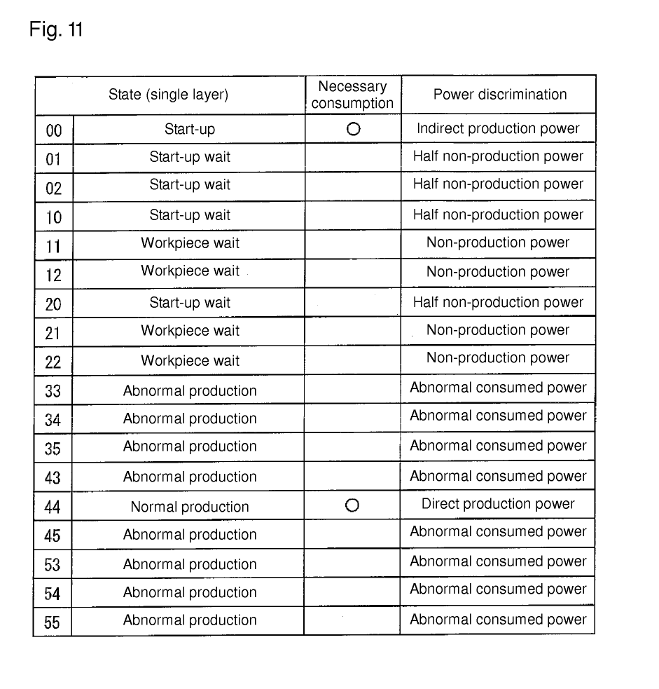

FIG. 11 is a view illustrating an example of the power discriminating condition stored in the condition storage unit 43 of the present embodiment.

As illustrated in FIG. 11, in the present embodiment, the power discriminating condition has the following data structure. The flag (a necessary consumption flag) indicating whether the power consumed in each of the conceivable states (determined by the state determining unit 30) in the drying oven 6 is the waste is stored while correlated with each state. The label indicating the grade of the power consumed in the state is also stored while correlated with each state. Although not illustrated, the wasted level may be stored while correlated with the item (except the states “00” and “44” in FIG. 11) that is classified as the unnecessary consumption. FIG. 11 illustrates the data structure of the power discriminating condition by way of example, but the present invention is not limited to the data structure of the power discriminating condition in FIG. 11.

Therefore, according to the power discriminating condition in FIG. 11, the power discriminating unit 31 can discriminate the detailed waste of the consumed power in the drying oven 6 having the plurality of drying layers based on the state of the drying oven 6, which is determined by the state determining unit 30. Specifically, the detailed waste of the consumed power in the drying oven 6 is discriminated as follows.

In the case that all the drying layers 9 are less than the proper temperature, the drying oven 6 is in the state of 00: start-up”. This is the process for all the drying layers 9 to reach the proper temperature. Therefore, the power discriminating unit 31 discriminates the power consumed in this state as the “indirect production power”.

In the case that one of the drying layer 9 reaches the proper temperature while the other drying layer 9 is in the start-up condition, the drying layer 9 that reaches the proper temperature may wait until the drying layer 9 in the start-up condition completes the preparation. The state is determined as the “start-up wait” (states “01”, “02”, “10”, and “20”). Part of the power consumed at that time is the “indirect production power” for the start-up, and part of the power is the “non-production power” in the standby state. Therefore, the power discriminating unit 31 discriminates the power consumed in this state as “half non-production power”.

In the case that all the drying layers 9 are greater than or equal to the proper temperature, it is considered that the start-up period of each layer is completed. When the start-up is completed, the work piece may be quickly input to start the production. At this point, the state in which the production activity is not performed without inputting the work piece is determined as the “work piece wait”. The power discriminating unit 31 discriminates the power consumed in this state as the “non-production power”.

When at least one of the drying layers 9 is out of the proper temperature range, the production cannot normally be performed, and there is a risk of ejecting the reject. At this point, in the case that the work piece is input, the state of the drying oven 6 is determined as the “abnormal production”. Therefore, the power discriminating unit 31 discriminates the power consumed in this state as the “abnormal consumed power”.

In the case that all the drying layers 9 fall within the proper temperature range, the work piece is input to perform the normal production. In this case, the state of the drying oven 6 is determined as the “normal production”. Therefore, the power discriminating unit 31 discriminates the power consumed in this state as the “direct production power”.

[State Determination Processing Flow]

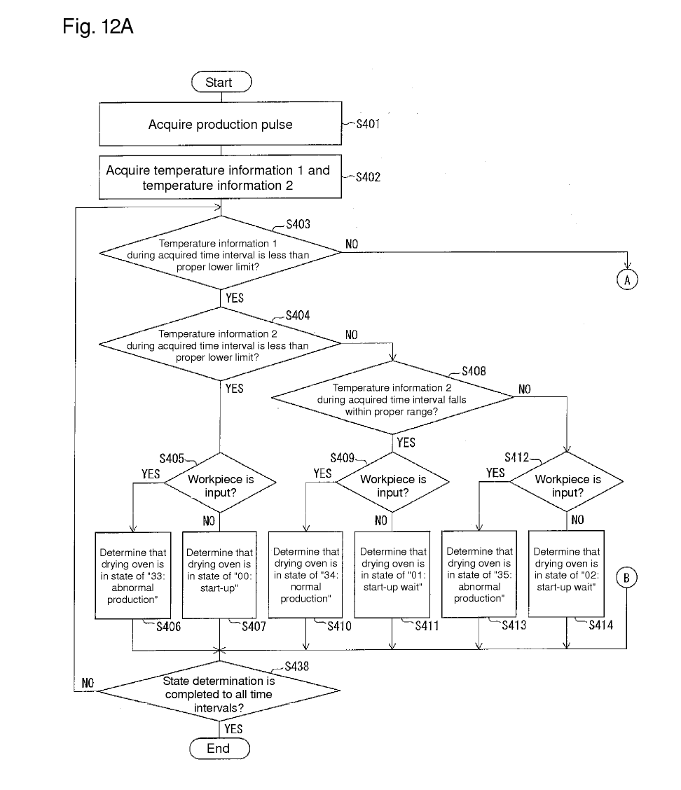

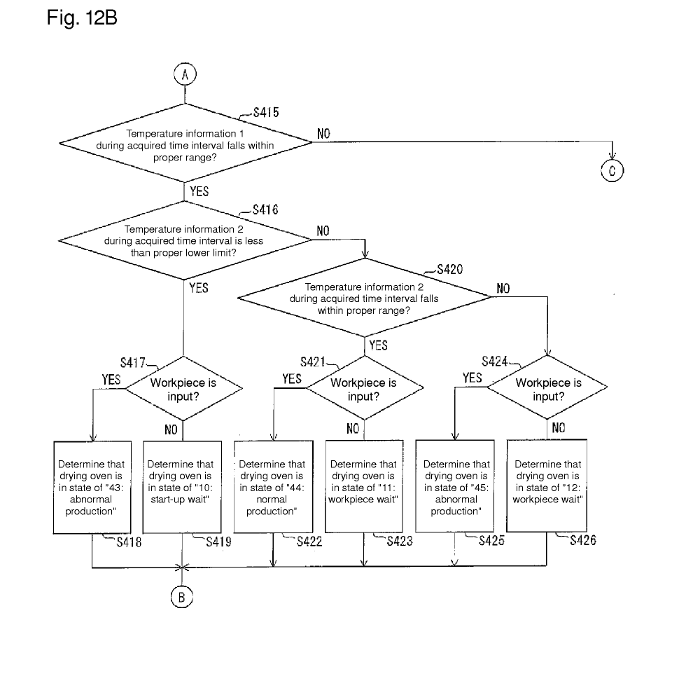

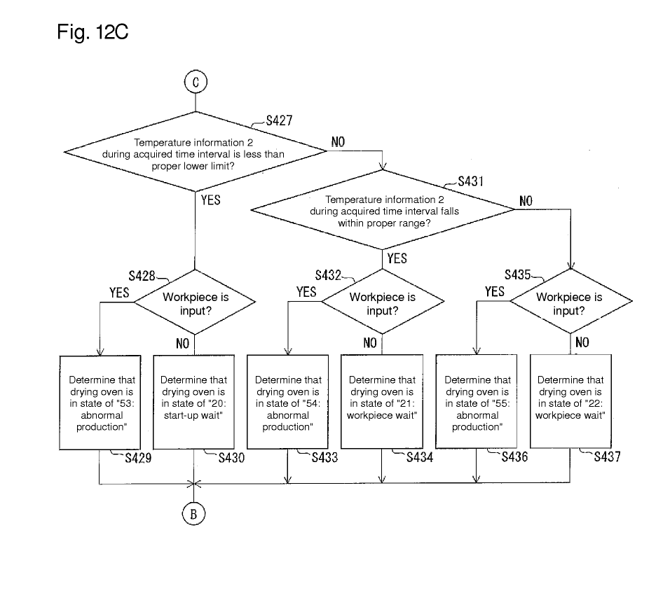

FIGS. 12A to 12C are a flowchart illustrating a flow of the state determination processing performed by the state determining unit 30 of the present embodiment.

As illustrated in FIG. 12A, the state determining unit 30 acquires the production pulse signal d3 (or the number of input work pieces) from the production pulse storage unit 42 (S401). The state determining unit 30 acquires the first in-layer temperature information d2a (hereinafter referred to as temperature information 1) on the drying layer 9a and the second in-layer temperature information d2b (hereinafter referred to as temperature information 2) on the drying layer 9b from the temperature information storage unit 41 (S402). The order in which the state determining unit 30 acquires the number of input work pieces and the order in which the state determining unit 30 acquires the temperature information may be replaced with each other.

In the present embodiment, the state determining unit 30 divides the time period of 9:00 to 10:30 into regular time intervals of 5 minutes, and determines the state of the drying oven 6 during each divided time interval. According to the state determination condition in FIGS. 10(a) and 10(b), the state determining unit 30 makes the determination as follows.

The state determining unit 30 determines whether the temperature information 1 during the acquired time interval is less than the proper lower limit (for example, 180° C.) (S403).

When the temperature information 1 on the drying layer 9a is less than the proper lower limit (YES in S403), the state determining unit 30 determines whether the temperature information 2 during the same time interval is less than the proper lower limit (for example, 120° C.) (S404).

When the temperature information 2 on the drying layer 9b is less than the proper lower limit (Yes in S404), the state determining unit 30 determines whether the number of input work pieces during the same time interval is zero or greater than zero (405). When the work piece is input during the time interval (the time period) (the number of input work pieces >0) (YES in S405), the state determining unit 30 determines that the drying oven 6 during the time interval is in the state of “33: abnormal production” (S406). On the other hand, when the work piece is not input during the time interval (the number of input work pieces=j) (NO in S405), the state determining unit 30 determines that the drying oven 6 during the time interval is in the state of “00: start-up” (S407).

On the other hand, when the temperature in the drying layer 9b is greater than or equal to the proper lower limit (NO in S404), the state determining unit 30 determines whether the temperature information 2 during the time interval falls within the production proper range (120 to 130° C.) (S408).

When the temperature in the drying layer 9b falls within the proper range (YES in S408), the state determining unit 30 determines whether the number of input work pieces during the time interval is zero or greater than zero (S409). When the work piece is input (YES in S409), the state determining unit 30 determines that the drying oven 6 during the time interval is in the state of “34: abnormal production” (S410). On the other hand, when the work piece is not input during the time interval (NO in S409), the state determining unit 30 determines that the drying oven 6 during the time interval is in the state of “01: start-up wait” (S411).

On the other hand, when the temperature in the drying layer 9b is out of the proper range, namely, when the oven temperature is greater than the proper upper limit (130° C.) (NO in S408), the state determining unit 30 determines whether the number of input work pieces during the time interval is zero or greater than zero (S412). When the work piece is input (YES in S412), the state determining unit 30 determines that the drying oven 6 during the time interval is in the state of “35: abnormal production” (S413). On the other hand, when the work piece is not input during the time interval (NO in S412), the state determining unit 30 determines that the drying oven 6 during the time interval is in the state of “02: start-up wait” (S414).

The pieces of processing in S404 to S414 are the flow when the temperature information 1 on the drying layer 9a is less than the lower limit. When the temperature information 1 is greater than or equal to the proper lower limit (NO in S403), the state determining unit 30 determines whether the temperature information 1 falls within the proper range (180 to 200° C.) as illustrated in FIG. 12B (S415).

When the temperature information 1 falls within the proper range (YES in S415), the state determining unit 30 determines whether the temperature information 2 on the drying layer 9b is less than the proper lower limit (120° C.) (S416).

When the temperature in the drying layer 9b is less than the proper lower limit (YES in S416), the state determining unit 30 determines whether the number of input work pieces during the same time interval is zero or greater than zero (S417). When the work piece is input during the time interval (the number of input work pieces >0) (YES in S417), the state determining unit 30 determines that the drying oven 6 during the time interval is in the state of “43: abnormal production” (S418). On the other hand, when the work piece is not input during the time interval (the number of input work pieces=0) (NO in S417), the state determining unit 30 determines that the drying oven 6 during the time interval is in the state of “10: start-up wait” (S419).

On the other hand, when the temperature in the drying layer 9b is greater than or equal to the proper lower limit (NO in S416), the state determining unit 30 determines whether the temperature information 2 during the time interval falls within the production proper range (120 to 130° C.) (S420).

When the temperature in the drying layer 9b falls within the proper range (YES in S420), the state determining unit 30 determines whether the number of input work pieces during the time interval is zero or greater than zero (S421). When the work piece is input (YES in S421), the state determining unit 30 determines that the drying oven 6 during the time interval is in the state of “44: normal production” (S422). On the other hand, when the work piece is not input during the time interval (NO in S421), the state determining unit 30 determines that the drying oven 6 during the time interval is in the state of “11: work piece wait” (S423).

On the other hand, when the temperature in the drying layer 9b is out of the proper range, namely, when the oven temperature is greater than the proper upper limit (130° C.) (NO in S420), the state determining unit 30 determines whether the number of input work pieces during the time interval is zero or greater than zero (S424). When the work piece is input (YES in S424), the state determining unit 30 determines that the drying oven 6 during the time interval is in the state of “45: abnormal production” (S425). On the other hand, when the work piece is not input during the time interval (NO in S424), the state determining unit 30 determines that the drying oven 6 during the time interval is in the state of “12: work piece wait” (S426).

The pieces of processing in S416 to S426 are the flow when the temperature information 1 on the drying layer 9a falls within the proper range. When the temperature information 1 is out of the proper range, namely, when the oven temperature is greater than the proper upper limit (200° C.) (NO in S415), the state determining unit 30 determines whether the temperature information 2 on the drying layer 9b is less than the proper lower limit (120° C.) as illustrated in FIG. 12C (S427).

When the temperature information 2 on the drying layer 9b is less than the proper lower limit (Yes in S427), the state determining unit 30 determines whether the number of input work pieces during the same time interval is zero or greater than zero (S428). When the work piece is input during the time interval (the number of input work pieces >0) (YES in S428), the state determining unit 30 determines that the drying oven 6 during the time interval is in the state of “53: abnormal production” (S429). On the other hand, when the work piece is not input during the time interval (the number of input work pieces=0) (NO in S428), the state determining unit 30 determines that the drying oven 6 during the time interval is in the state of “20: start-up wait” (S430).

On the other hand, when the temperature in the drying layer 9b is greater than or equal to the proper lower limit (NO in S427), the state determining unit 30 determines whether the temperature information 2 during the time interval falls within the production proper range (120 to 130° C.) (S431).

When the temperature information 2 on the drying layer 9b falls within the proper range (YES in S431), the state determining unit 30 determines whether the number of input work pieces during the time interval is zero or greater than zero (S432). When the work piece is input (YES in S432), the state determining unit 30 determines that the drying oven 6 during the time interval is in the state of “54: abnormal production” (S433). On the other hand, when the work piece is not input during the time interval (NO in S432), the state determining unit 30 determines that the drying oven 6 during the time interval is in the state of “21: work piece wait” (S434).

On the other hand, when the temperature information 2 on the drying layer 9b is out of the proper range, namely, when the oven temperature is greater than the proper upper limit (130° C.) (NO in S431), the state determining unit 30 determines whether the number of input work pieces during the time interval is zero or greater than zero (S435). When the work piece is input (YES in S435), the state determining unit 30 determines that the drying oven 6 during the time interval is in the state of “55: abnormal production” (S436). On the other hand, when the work piece is not input during the time interval (NO in S435), the state determining unit 30 determines that the drying oven 6 during the time interval is in the state of “22: work piece wait” (S437).

The pieces of processing in S427 to S437 are the flow when the temperature information 1 on the drying layer 9a is greater than the proper upper limit.

When the time interval in which the state determination is not made yet remains after the state of the drying oven 6 during one time interval is determined as one of 18 ways in FIG. 10(b) (NO in S438 of FIG. 12A), the state determining unit 30 repeats the pieces of processing in S403 to S437 with respect to the next time interval.

On the other hand, when the state determination is completed to all the time intervals (YES in S438), the state determining unit 30 outputs the state determination results of all the time intervals to the power discriminating unit 31, and ends the state determination processing.

[Power Discriminating Processing Flow]

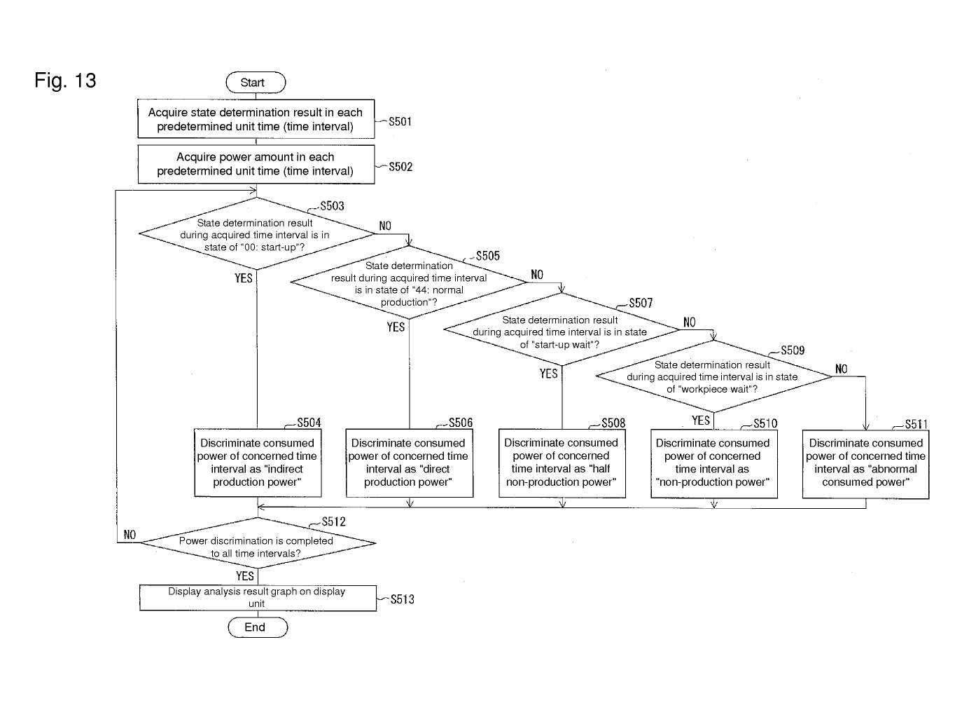

FIG. 13 is a flowchart illustrating a flow of the power discriminating processing performed by the power discriminating unit 31 of the present embodiment.

Like FIG. 7, the power discriminating unit 31 acquires the state determination processing results of all the time intervals from the state determining unit 30 in each time interval (S501), and the power discriminating unit 31 acquires the consumed power amounts of all the time intervals from the electric energy storage unit 40 in each time interval (S502).

When the drying oven 6 during the acquired time interval (for example, 9:00 to 9:05) is in the state of “00: start-up” (YES in S503), the power discriminating unit 31 discriminates the consumed power during the time interval as the “indirect production power” according to the power discriminating condition in FIG. 11 (S504). When the drying oven 6 is in the state of “44: normal production” (NO in S503 and YES in S505), the power discriminating unit 31 discriminates the consumed power during the time interval as the “direct production power” (S506). When the drying oven 6 during the time interval is in the state of “start-up wait” (NO in S503, NO in S505, and YES in S507), the power discriminating unit 31 discriminates the consumed power during the time interval as the “half non-production power” (S508). When the drying oven 6 during the time interval is in the state of “work piece wait” (NO in S503, NO in S505, NO in S507, and YES in S509), the power discriminating unit 31 discriminates the consumed power during the time interval as the “non-production power” (S510). When the drying oven 6 during the time interval is in the state of “abnormal production” (NO in S503, NO in S505, NO in S507, and NO in S509), the power discriminating unit 31 discriminates the consumed power during the time interval as the “abnormal consumed power” (S511).

When the time interval during which the power discrimination is not performed yet remains after the power discrimination is performed to the time interval (NO in S512), the state determination processing result during the next time interval (for example, 9:05 to 9:10) is acquired to repeat the pieces of processing in S503 to S511.

When the power discrimination is performed to all the time intervals (for example, 9:00 to 10:30) (YES in S512), the power discriminating unit 31 outputs the power discriminating processing results of all the time intervals to the result graph generating unit 32. Based on the power discriminating processing result output from the power discriminating unit 31, the result graph generating unit 32 generates the result graph, and displays the result graph on the display unit 23 (S513). Then the power discriminating processing is ended.

In the power discriminating processing, from the viewpoint of discriminating the waste of the consumed power, the consumed power can correctly be discriminated according to the state of the drying oven 6 while the power discriminating processing result can easily be presented to the user. Additionally, in the power discriminating processing of the present embodiment, in the case that the drying oven 6 includes the plurality of drying layers 9 having the different proper temperatures, or in the case of the plurality of production devices, such as the drying oven 6, which are of the monitoring targets, the waste of the consumed power can be discriminated.

[Result Graph]

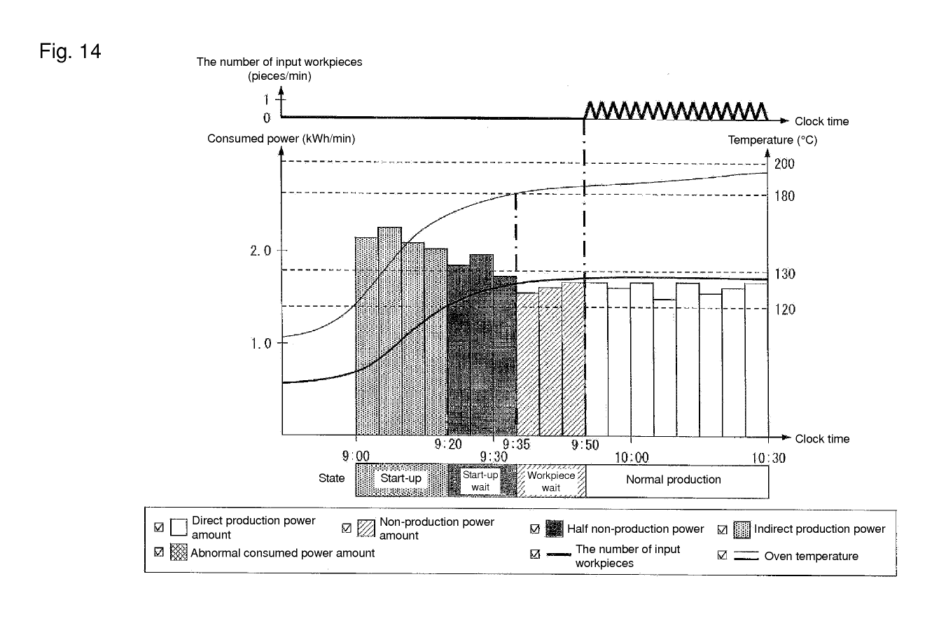

FIG. 14 is a view illustrating an example of the result graph generated by the result graph generating unit 32 of the present embodiment.

Like FIG. 8, the upper two-dimensional graph expresses the clock time and the transition of the number of input work pieces. The lower two-dimensional graph (the bar graph) expresses the clock time and the transition of the consumed power amount of the drying oven 6. The bar graph is a graph (bar graph) that also expresses the consumed power discrimination result. The graph (the line graph) indicating the transition of the temperatures in the drying layers 9a and 9b may be plotted in the lower two-dimensional graph.

The result graph in FIG. 14 differs from the result graph in FIG. 8 in that the line graph indicating the transition of the temperature is plotted in each of the drying layers 9 having the different proper temperatures. In the lower graph, a thin line expresses the temperature in the drying layer 9a, and a bold line expresses the temperature in the drying layer 9b.

In the result graph in FIG. 14, the color-coded bar expressing the power used amount is displayed in each bin of the time interval of 5 minutes and in each power discrimination label. Therefore, the user can check the waste of the consumed power at a glance by checking the result graph from the display unit 23.

For example, during the time interval (the time period of 9:00 to 9:20) in which each drying layer 9 does not reach the proper temperature since the power is turned on, it is found that the drying oven 6 is in the state of “start-up”, and that the power consumed at this point is the “indirect production power”.

The time interval (the time period of 9:20 to 9:35) in which the drying layer 9a reaches the proper temperature since the drying layer 9b reaches the proper temperature is the state of “start-up wait” in which the drying layer 9b waits for the start-up of the drying layer 9a. In the state of “start-up wait”, the power consumed for the drying layer 9b becomes the waste. Therefore, the “half non-production power” is preferably decreased as much as possible. That is, the time period of 9:20 to 9:35 is preferably shortened as much as possible. As is clear from the result graph in FIG. 14, the user can instantaneously judge that the period of the state of “start-up wait” is shortened (or eliminated) by starting up the drying layer 9a 15 minutes early. Thus, the result graph generated by the result graph generating unit 32 largely contributes to the presentation to the user of the problematic point and improvement of the current production management system.

[Modification]

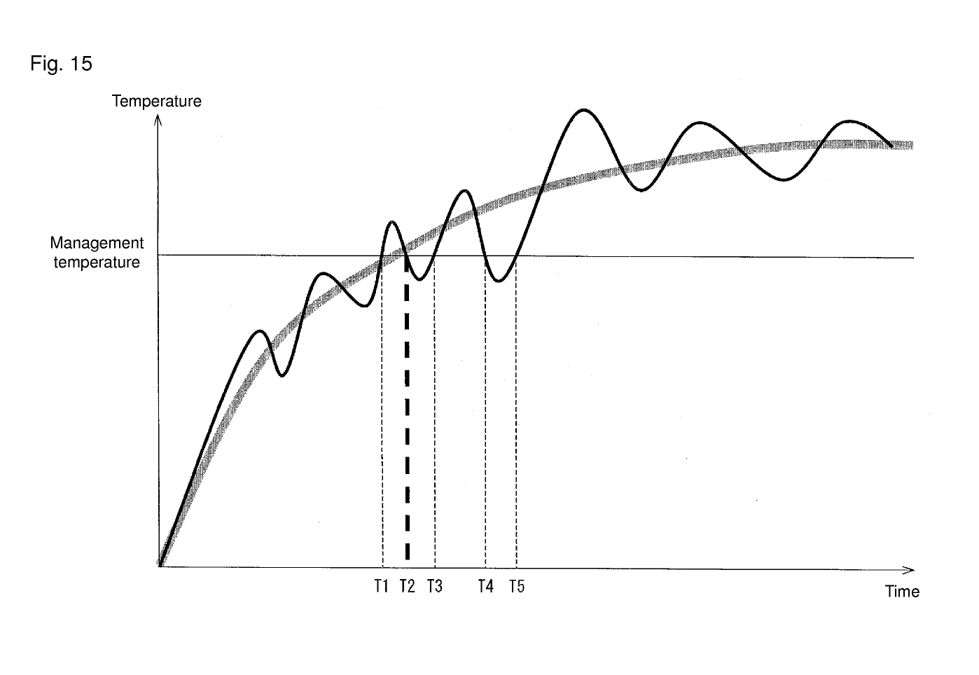

FIG. 15 is a graph illustrating a relationship between a fluctuation in monitored temperature and a threshold (a management temperature) specifying the temperature proper range.

For example, in the case that the temperature measured by the thermometer 7 (thermometers 7a and 7b) changes largely at extremely short time intervals (for example, several seconds or several tenths of a second) in the embodiments, whether the oven temperature is greater than a threshold changes quickly in a short period. When the state determination processing and the power discriminating processing are performed in association with the extremely short time interval, unfortunately a processing load of the production management device 1 increases to significantly lower efficiency of processing of deriving the result. When a specific time point is interleaved and picked up to perform the state determination processing and the power discriminating processing, there is a possibility that the temperature of the specific time point happens to be excessively lower (higher) than surrounding time points, and unfortunately the correct result cannot be derived.

For example, particularly, the period (T1 to T5) during which the oven temperature transitions around the threshold (the management temperature) is the extremely short periods of T1 to T2, T2 to T3, T3 to T4, and T4 to T5, and the situation of the drying oven 6 changes alternately, which possibly results in a problem of the processing efficiency or correctness of the processing.

For this reason, the data processing unit 33 of the production management device 1 may obtain a temperature average value at relatively long regular time intervals, derive a polygonal line (or an approximate curve (a gray bold line) in FIG. 15) passing through the points of the plotted temperature average value, and store the polygonal line in the temperature information storage unit 41.

Therefore, the processing of the state determining unit 30 is simplified, and the state determining unit 30 can efficiently perform the state determination processing at a low load.

[Modification 2]

In the embodiments, the state determining unit 30 is configured to perform the state determination processing while considering only the in-layer temperature as the information obtained from the in-layer temperature information d2 (d2a and d2b). However, the configuration of the state determining unit 30 of the present invention is not limited to the configuration of the embodiments.

The state determining unit 30 may be configured to perform the state determination processing while considering another piece of information obtained by statistical processing of the in-layer temperature information d2.

For example, in the production management system 100 (200), the in-layer temperature tends to rapidly rise in a short period when the drying layer 9 of the drying oven 6 is in the start-up state. When the state determination condition is fixed in consideration of the tendency, the state determining unit 30 can judge whether the drying oven 6 is in the start-up state according to a rate of temperature rise.

(State Determination Condition)

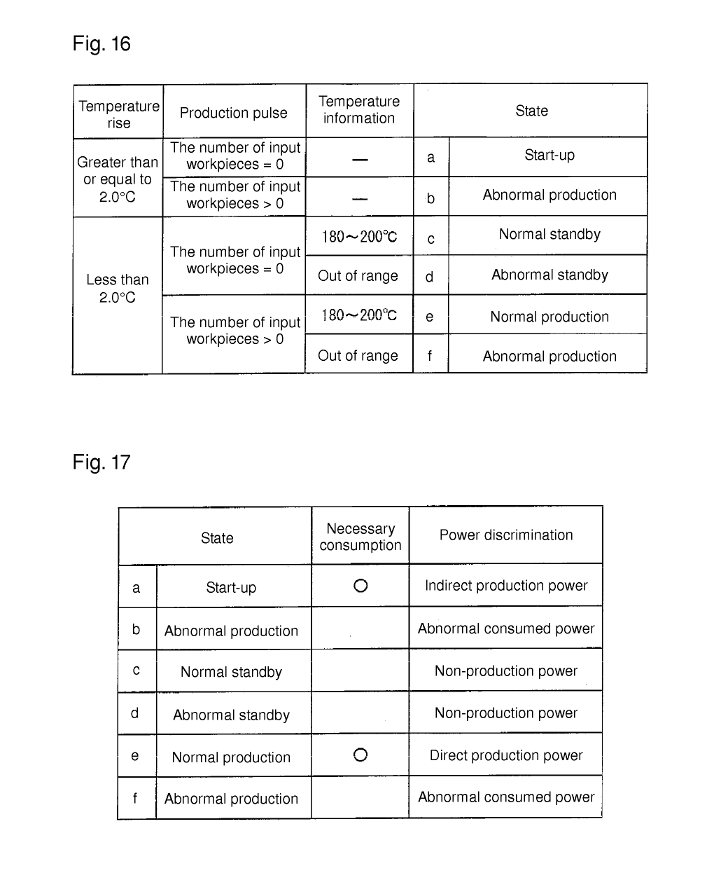

FIG. 16 is a view illustrating an example of the state determination condition stored in the condition storage unit 43 of the production management device 1 in the present modification. In the example in FIG. 16, it is assumed that the drying oven 6 includes one layer. However, the present modification may be applied to the case that the drying oven 6 includes a plurality of layers.

As illustrated in FIG. 16, the state determination condition may have the following data structure. The conceivable state of the drying oven 6 is stored while correlated with each of a combination of (1) the condition of the temperature in the drying layer 9 in the predetermined time period, (2) the condition of the number of input work pieces, and (3) a condition of a temperature rise width in the predetermined time period compared with the temperature immediately before the time period.

Under the condition that the temperature rise is greater than or equal to 2.0° C., the state determining unit 30 may be configured to determine the state of the drying oven 6 not by referring to (1) the condition of the temperature, but only by the combination of (2) the condition of the number of input work pieces. Accordingly, in the example in FIG. 16, the state determination condition has a structure in which the combination of (2) the condition of the number of input work pieces and (3) the condition of the temperature rise is correlated with the “state”.

Specifically, under the condition that the temperature rise is greater than or equal to 2.0° C., the state of “a: start-up” is stored while correlated with the condition that the work piece is not input. On the other hand, the generation of the rapid temperature rise during the production is determined to be abnormal, and the state of “b: abnormal production” is stored while correlated with the condition that the work piece is input.

As illustrated in FIG. 16, under the condition that the in-layer temperature is stabilized because the temperature rise is less than 2.0° C., the states of “c: normal standby”, “d: abnormal standby”, “e: normal production”, and “f: abnormal production” are stored while correlated with whether the work piece is input and whether the in-layer temperature falls within the proper range.

According to the state determination condition, the state determining unit 30 can correctly determine the state of the drying oven 6 based on not only the production pulse but also the temperature rise and the temperature.

(Power Discriminating Condition)

FIG. 17 is a view illustrating an example of the power discriminating condition stored in the condition storage unit 43 of the production management device 1 in the present modification.

As illustrated in FIG. 17, the power discriminating condition has the data structure in which the necessary consumption flag and the power discriminating label are stored while correlated with the “state”, which is determined by the state determining unit 30 according to the state determination condition in FIG. 17.

Although not illustrated, the wasted level may be stored while correlated with the item that is classified as the unnecessary consumption like the example in FIG. 4.

Therefore, according to the power discriminating condition in FIG. 17, the power discriminating unit 31 can discriminate the waste of the consumed power in the drying oven 6 based on the state of the drying oven 6, which is determined by the state determining unit 30.

(State Determination and Power Discriminating Processing Flow)

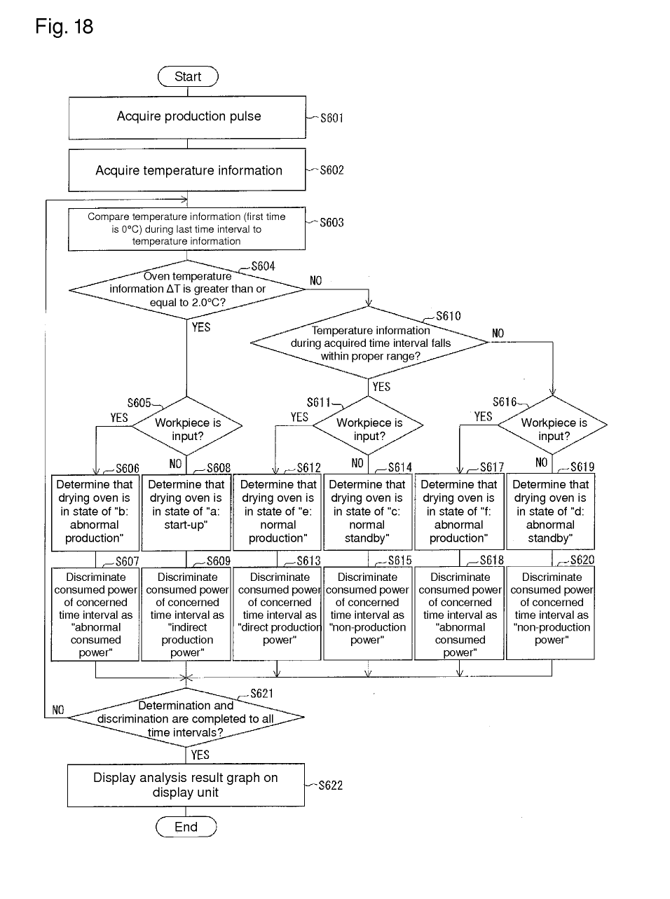

FIG. 18 is a flowchart illustrating a flow of the state determination processing performed by the state determining unit 30 and the power discriminating processing performed by the power discriminating unit 31.

The state determining unit 30 acquires the production pulse signal d3 (or the number of work piece inputs) from the production pulse storage unit 42, and acquires the in-layer temperature information d2 (hereinafter referred to as temperature information) from the temperature information storage unit 41 (S601 and S602).

The state determining unit 30 and the power discriminating unit 31 divide the whole time period of the acquired information into regular time intervals (for example, 5 minutes and 10 minutes), and makes the state determination and power discrimination of the drying oven 6 during each divided time interval. According to the state determination condition in FIG. 16 and the power discriminating condition in FIG. 17, the state determining unit 30 and the power discriminating unit 31 perform the determination and discrimination as follows.

The state determining unit 30 compares the temperature information (for the first time, for example, 0° C. or room temperature of the facility) during the time interval immediately before the acquired time interval to the temperature information during the acquired time interval (S603).

The state determining unit 30 determines whether a temperature rise width ΔT is greater than or equal to 2.0° C. (S604).

When the temperature rise in the drying layer 9 is greater than or equal to 2.0° C. (YES in S604), the state determining unit 30 determines whether the number of input work pieces during the acquired time interval is zero or greater than zero (S605). When the number of input work pieces during the time interval is greater than zero (the number of input work pieces >0) (YES in S605), the state determining unit 30 determines the drying oven 6 during the time interval as the state of “b: abnormal production” (S606). Based on the result of the state determination made in S606, the power discriminating unit 31 discriminates the consumed power of the drying oven 6 during the time interval as the “abnormal consumed power” (S607). On the other hand, when the work piece is not input (the number of input work pieces=0) (NO in S605), the state determining unit 30 determines the drying oven 6 during the time interval as the state of “a: start-up” (S608). Based on the result of the state determination made in S608, the power discriminating unit 31 discriminates the consumed power of the drying oven 6 during the time interval as the “indirect production power” (S609).

On the other hand, when the temperature rise width ΔT in the drying layer 9 is less than 2.0° C. (NO in S604), the state determining unit 30 determines whether the temperature information during the time interval falls within the production proper range (180 to 200° C.) (S610).

When the temperature in the drying layer 9 falls within the proper range (YES in S610), the state determining unit 30 determines whether the number of input work pieces during the time interval is zero or greater than zero (S611). When the work piece is input (YES in S611), the state determining unit 30 determines the drying oven 6 during the time interval as the state of “e: normal production” (S612). Based on the result of the state determination made in S612, the power discriminating unit 31 discriminates the consumed power of the drying oven 6 during the time interval as the “direct production power” (S613). On the other hand, when the work piece is not input (NO in S611), the state determining unit 30 determines the drying oven 6 during the time interval as the state of “c: normal standby” (S614). Based on the result of the state determination made in S614, the power discriminating unit 31 discriminates the consumed power of the drying oven 6 during the time interval as the “non-production power” (S615).

When the temperature in the drying layer 9 is out of the proper range, namely, when the oven temperature is less than the proper lower limit (180° C.), or greater than the proper upper limit (200° C.) (NO in S610), the state determining unit 30 determines whether the number of input work pieces during the time interval is zero or greater than zero (S616). When the work piece is input (YES in S616), the state determining unit 30 determines the drying oven 6 during the time interval as the state of “f: abnormal production” (S617). Based on the result of the state determination made in S617, the power discriminating unit 31 discriminates the consumed power of the drying oven 6 during the time interval as the “abnormal consumed power” (S618). When the work piece is not input (NO in S616), the state determining unit 30 determines the drying oven 6 during the time interval as the state of “d: abnormal standby” (S619). Based on the result of the state determination made in S619, the power discriminating unit 31 discriminates the consumed power of the drying oven 6 during the time interval as the “non-production power” (S620).

When the time interval during which the state determination and the power determination are not made yet remains after one of the states “a” to “f” is determined with respect to the time interval or the power discrimination is performed (NO in S621), the temperature information and the number of input work pieces during the next time interval are acquired to repeat the pieces of processing in S603 to S620.

When the state determination is made to all the time intervals (YES in S621), the state determining unit 30 outputs the state determination processing results of all the time intervals to the result graph generating unit 32, and the power discriminating unit 31 outputs the power discriminating processing results of all the time intervals to the result graph generating unit 32. Based on the state determination processing results and the power discriminating processing results, the result graph generating unit 32 generates the result graph and displays the result graph on the display unit 23 (S622). Therefore, the state determination processing and the power discriminating processing are ended.

In the method of the second modification, the production management device 1 can extract two parameters, namely, the “temperature” and the “temperature rise width” obtained by the statistical processing of the information on the “temperature” from the in-layer temperature information d2, and make the state determination of the drying oven 6.

[Third Modification]

In the configuration of the embodiments, the state determining unit 30 determines the production/non-production of the drying oven 6 based on the production pulse, which is obtained such that the sensor 12 monitors the number of work pieces input to the drying oven 6, and the state determination processing is performed by referring to the information on the production/non-production. However, the present invention is not limited to the above configuration of the state determining unit 30.

The sensor 12 may monitor another motion except the number of input work pieces to determine the production/non-production by another method.

(Outline of Production Management System)

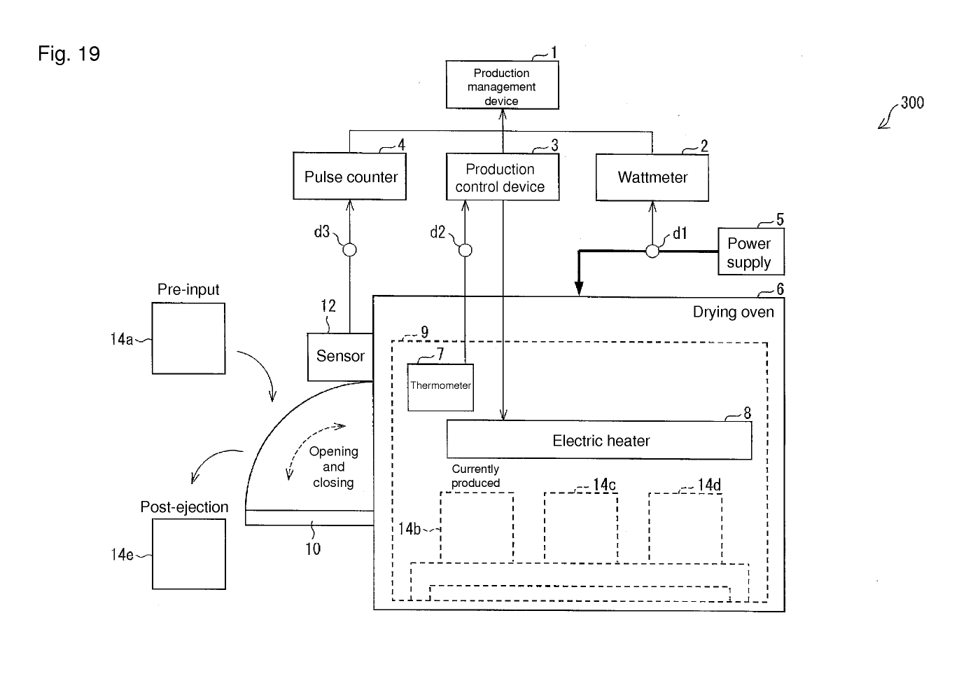

FIG. 19 is a view illustrating an outline of a production management system 300 according to a third embodiment of the present invention.

As illustrated in FIG. 19, the drying oven 6 includes the input port 10 constructed by a door that is commonly used as the input port and the ejection port. In the production management system 300, the work piece 14 is input and taken off through the input port 10 (such as the pre-input work piece 14a and the post-ejection work piece 14e). The work piece 14 may automatically be input and taken off using a machine, or manually be input and taken off.

The drying oven 6 is configured such that the door (input port 10) is closed only when the drying oven 6 operates to produce the work piece 14. That is, the ejection and input of the work piece 14 are completed to place the work pieces 14b to 14d of the production target in the drying layer 9, the input port 10 is closed, and the electric heater 8 operates. When the drying is completed to take off the work piece 14, the electric heater 8 does not operate, but the input port 10 is opened. That is, the drying oven 6 currently performs the production when the input port 10 is closed, and the drying oven 6 does not currently perform the production when the input port 10 is opened.

Therefore, for example, in the third modification, the sensor 12 is configured to sense opening and closing of the door (the input port 10) through which the work piece 14 is input and taken off.

The sensor 12 senses the state in which the door is closed or opened, and the sensor 12 outputs production pulse signal d3 to the pulse counter 4. In the production pulse signal d3, the state in which the door is closed is expressed by a close signal (for example, the ON signal), and the state in which the door is opened is expressed by an OFF signal.

The pulse counter 4 supplies the ON/OFF signal (the production pulse signal d3) acquired from the sensor 12 to the production management device 1 while correlating the ON/OFF signal with the clock time information. In the case that the production management device 1 includes the function of the pulse counter 4, the production management device 1 may directly acquire the production pulse signal d3 from the sensor 12.

(State Determination Condition)

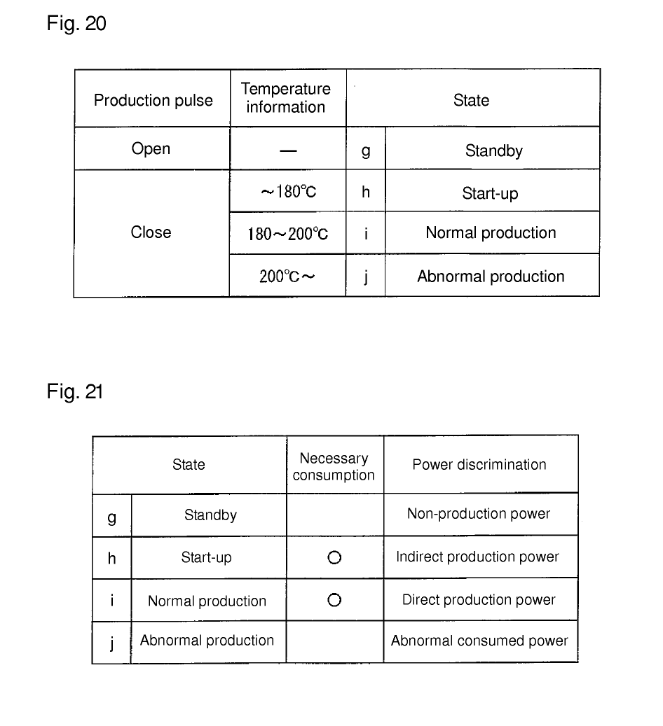

FIG. 20 is a view illustrating an example of the state determination condition stored in the condition storage unit 43 of the production management device 1 in the third modification.

As illustrated in FIG. 20, in the state determination condition, the conceivable state of the drying oven 6 is stored while correlated with each of a combination of (1) the condition of the opening and closing of the door of the drying oven 6 in the predetermined time period and (2) the condition of the temperature in the drying layer 9 in the predetermined time period.

As described above, the state (non-production) of the wait for the work piece to be input and taken off is fixed under the condition of the opened door. Therefore, under the condition of the opened door, the state of the drying oven 6 may uniquely be determined as “standby” without referring to the condition of the temperature. Accordingly, in the example of the state determination condition in FIG. 20, the condition of the opened door is correlated with the state of “g: standby”.

The state in which the work piece 14 is input to the drying layer 9 of the drying oven 6 while the electric heater 8 operated is fixed under the condition of the closed door. Therefore, in the state determination condition, the combination of the condition of the closed door and the condition that “the temperature information is less than the proper lower limit” is correlated with the state of “h: start-up”. The combination of the condition of the closed door and the condition that “the temperature information falls within the proper range” is correlated with the state of “i: normal production”. The combination of the condition of the closed door and the condition that “the temperature information is greater than the proper upper limit” is correlated with the state of “j: abnormal production”.

(Power Discriminating Condition)

FIG. 21 is a view illustrating an example of the power discriminating condition stored in the condition storage unit 43 of the production management device 1 in the third modification.

As illustrated in FIG. 21, the power discriminating condition has the data structure in which the necessary consumption flag and the power discriminating label are stored while correlated with the “state”, which is determined by the state determining unit 30 according to the state determination condition in FIG. 20.

Although not illustrated, the wasted level may be stored while correlated with the item that is classified as the unnecessary consumption like the example in FIG. 4.

Therefore, according to the power discriminating condition in FIG. 21, the power discriminating unit 31 can discriminate the waste of the consumed power in the drying oven 6 based on the state of the drying oven 6, which is determined by the state determining unit 30.

Specifically, the power discriminating unit 31 discriminates the power consumed by the drying oven 6 in the state of “g: standby” as the “non-production power”, discriminates the power consumed by the drying oven 6 in the state of “h: start-up” as the “indirect production power”, discriminates the power consumed by the drying oven 6 in the state of “i: normal production” as the “direct production power”, and discriminates the power consumed by the drying oven 6 in the state of “j: abnormal production” as the “abnormal consumed power”.

[Fourth Modification]

In the embodiments, the thermometer 7 is provided in the drying layer 9 of the drying oven 6, and the state determining unit 30 determines the state of the drying oven 6 based on the temperature information on the drying layer 9. However, the present invention is not limited to the above configuration of the state determining unit 30.

The production management device 1 of the present invention can extract the waste by monitoring the consumption of the resource with respect to not only the drying oven 6 but also any production device. That is, the production management device 1 of the present invention can monitor the environment change physical amount of the production device to discriminate the waste of the consumption of the resource, as long as the production device produces the product with the change in the environment change physical amount (the production environment such as temperature, atmospheric pressure, vapor pressure, pressure, humidity, a degree of oxygen saturation, and density of a specific substance) by consuming the consumption resource (such as the power, gas, water, and gasoline)

In the fourth modification, an example of the production management device 1 that monitors a sterilization device sterilizing the work piece (such as a food and a medical tool) using a given vapor pressure (and high temperature) will be described below as another example of the present invention.

(Outline of Production Management System)

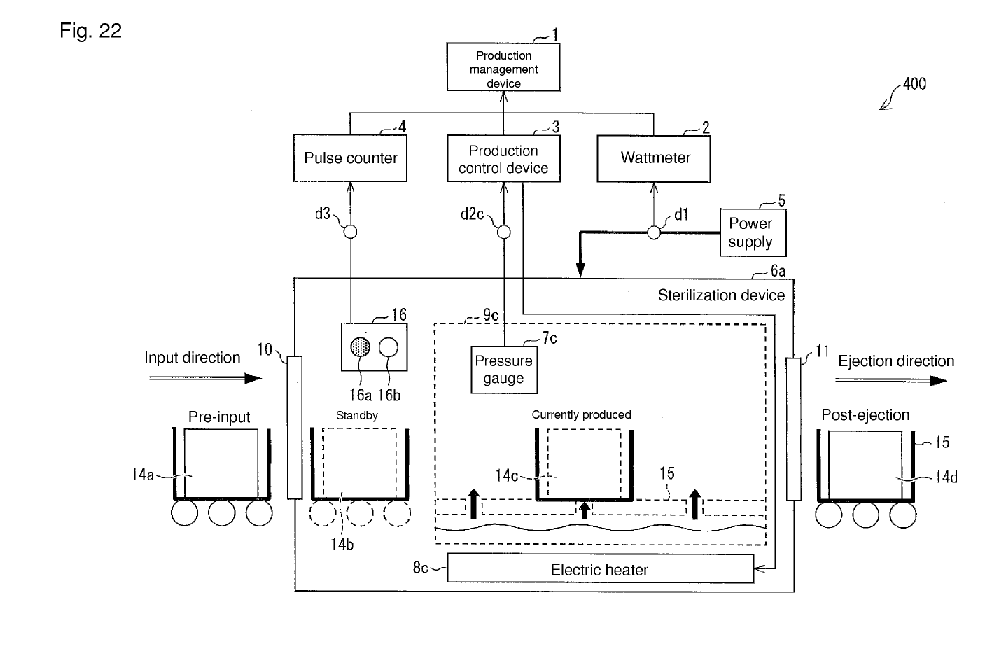

FIG. 22 is a view illustrating an outline of a production management system 400 of the fourth embodiment of the present invention.

As illustrated in FIG. 22, instead of the drying oven 6, the production management system 400 includes a sterilization device 6a which is the production device.

The sterilization device 6a is the production device that sterilizes bacteria adhering to the work piece. The sterilization device 6a includes a pressure gauge 7c, an electric heater 8c, a sterilization tank 9c, and an operating button unit 16.

The sterilization tank 9c provides a space filled with the high-temperature water vapor, and is made of a heat-resistant and heat insulating material. The sterilization tank 9c includes a heat-resistant partition 15 that permeates the water vapor, and a lower space of the partition 15 is filled with water such that the high-temperature water vapor is delivered to an upper space of the partition 15. The work piece 14 is placed in the upper space of the partition 15, and sterilization work is performed to the work piece 14 using the high-temperature water vapor filling the upper space. Although not illustrated, a sprinkler may be provided in the sterilization tank 9c in order to spray the upper space with a medical agent.

The electric heater 8c vaporizes the water filling the lower space of the sterilization tank 9c by heating up the water to high temperature.

The pressure gauge 7c measures a pressure (a vapor pressure) in the sterilization tank 9c. Vapor pressure information d2c measured by the pressure gauge 7c is output to the production control device 3, and supplied from the production control device 3 to the production management device 1. In the fourth modification, it is assumed that a proper vapor pressure range in the sterilization tank 9c ranges from XI to Xu (kPa) during the sterilization work. The vapor pressure information d2c may directly be supplied from the pressure gauge 7c to the production management device 1.

The operating button unit 16 is constructed by various buttons in order to operate the sterilization device 6a. The operating button unit 16 includes at least a start button 16a that issues an instruction to start the sterilization work.

A flow of the production is as follows. Before the work piece 14 is placed in the sterilization tank 9c, the electric heater 8c of the sterilization device 6a is operated to cause the sterilization tank 9c to reach a predetermined vapor pressure (and temperature). When the sterilization tank 9c reaches the proper vapor pressure, the work piece 14 is automatically placed from a standby position into the sterilization tank 9c. The state up to here can be defined as the “start-u p”.

Then, a worker checks the condition that the sterilization work can be performed, and presses the start button 16a. Therefore, the “production” is started. That is, when the start button 16a is pressed, the production control device 3 starts the measurement of the time, monitors the pressure gauge 7c, and controls the electric heater 8c to maintain the sterilization tank 9c at a predetermined vapor pressure for a predetermined time. This state can be defined as the sterilization work state in the sterilization device 6a, namely, the “production”.

When the predetermined time elapses, the production control device 3 controls the sterilization device 6a to put the electric heater 8c in the non-operation state, ejects the work piece 14 (the work piece 14c to the work piece 14d) in which the production is completed, and places the standby work piece 14b in the sterilization tank 9c. In this period, the worker may input the pre-input work piece 14a to a standby position in the sterilization device 6a.

The state in which the work piece 14 is input or ejected by manpower or a machine can be defined as a sterilization preparation state, namely, the “non-production”.

The operating button unit 16 may further include an emergency stop button 16b such that emergency stop of the sterilization device 6a can be performed even in the sterilization work.

The operating button unit 16 is connected to the pulse counter 4, and outputs the press situation of each button, which is operated by the worker, as the production pulse signal d3 to the pulse counter 4. In the fourth modification, the operating button unit 16 outputs the production pulse signal d3 to the pulse counter 4. In the production pulse signal d3, the state in which the start button 16a is pressed to continue the sterilization work for the predetermined time is expressed by the ON signal, and the state in which the predetermined time elapses to input or eject the work piece 14 or the state in which the emergency stop of the sterilization device 6a is performed is expressed by the OFF signal.

(State Determination Condition)

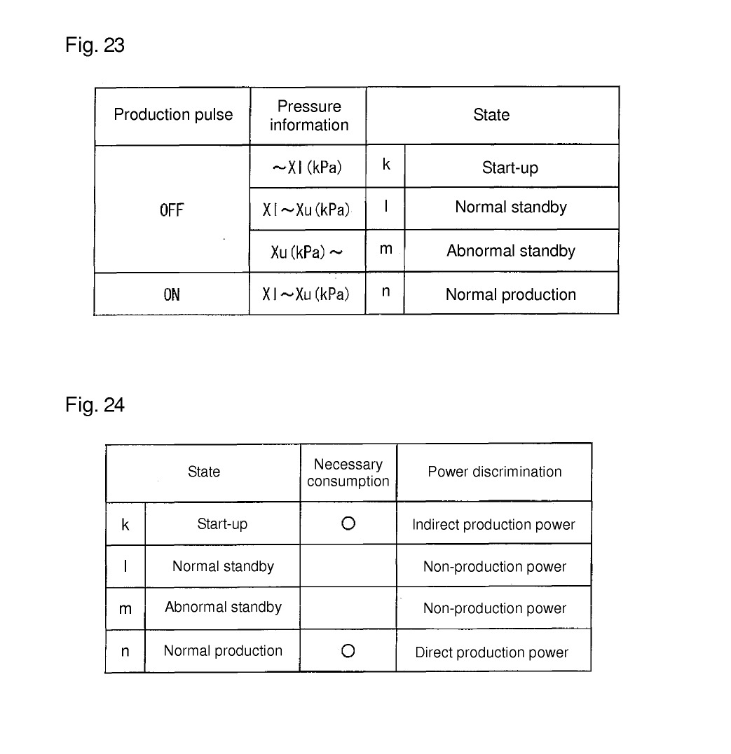

FIG. 23 is a view illustrating an example of the state determination condition stored in the condition storage unit 43 of the production management device 1 in the fourth modification.

As illustrated in FIG. 23, in the state determination condition, the conceivable state of the sterilization device 6a is stored while correlated with each of a combination of (1) the condition whether the sterilization device 6a currently performs the sterilization work in a predetermined time period and (2) the condition of the vapor pressure in the sterilization tank 9c in the predetermined time period.

Under the condition that the sterilization device 6a currently performs the sterilization work, in the sterilization tank 9c, it is fixed that the vapor pressure falls within the proper range. The start button 16a is configured not to be pressed unless the sterilization tank 9c falls within the proper range, and the sterilization work is relatively short period. Therefore, once the vapor pressure is stabilized within the proper range, the vapor pressure does not largely fluctuate in a short period. For this reason, under the condition that the sterilization device 6a currently performs the sterilization work (the ON signal), the state of the sterilization device 6a may uniquely be determined as the normal production without referring to the condition of the pressure information. Accordingly, in the example of the state determination condition in FIG. 23, the condition of the “ON signal (sterilization work state)” is correlated with the state of “n: normal production”.

The start-up and the input of the work piece 14 are performed under the condition of the sterilization preparation state (the OFF signal). Therefore, in the state determination condition, the combination of the condition of the “OFF signal (sterilization preparation state)” and the condition that “the pressure information is less than the proper lower limit” is correlated with the state of “k: start-up”. The combination of the condition of the “OFF signal (sterilization preparation state)” and the condition that “the pressure information falls within the proper range” is correlated with the state of “I: normal standby”. The combination of the condition of the “OFF signal (sterilization preparation state)” and the condition that “the pressure information is greater than the proper upper limit” is correlated with the state of “m: abnormal standby”.

(Power Discriminating Condition)

FIG. 24 is a view illustrating an example of the power discriminating condition stored in the condition storage unit 43 of the production management device 1 in the fourth modification.

As illustrated in FIG. 24, the power discriminating condition has the data structure in which the necessary consumption flag and the power discriminating label are stored while correlated with the “state”, which is determined by the state determining unit 30 according to the state determination condition in FIG. 23.

Although not illustrated, the wasted level may be stored while correlated with the item that is classified as the unnecessary consumption like the example in FIG. 4.

Therefore, according to the power discriminating condition in FIG. 23, the power discriminating unit 31 can discriminate the waste of the consumed power in the sterilization device 6a based on the state of the sterilization device 6a, which is determined by the state determining unit 30.

Specifically, the power discriminating unit 31 discriminates the power consumed by the sterilization device 6a in the state of “k: start-up” as the “indirect production power”, discriminates the power consumed by the sterilization device 6a in the state of “l: normal standby” as the “non-production power”, discriminates the power consumed by the sterilization device 6a in the state of “m: abnormal standby” as the “non-production power”, and discriminates the power consumed by the sterilization device 6a in the state of “n: normal production” as the “direct production power”.

(Result Graph)

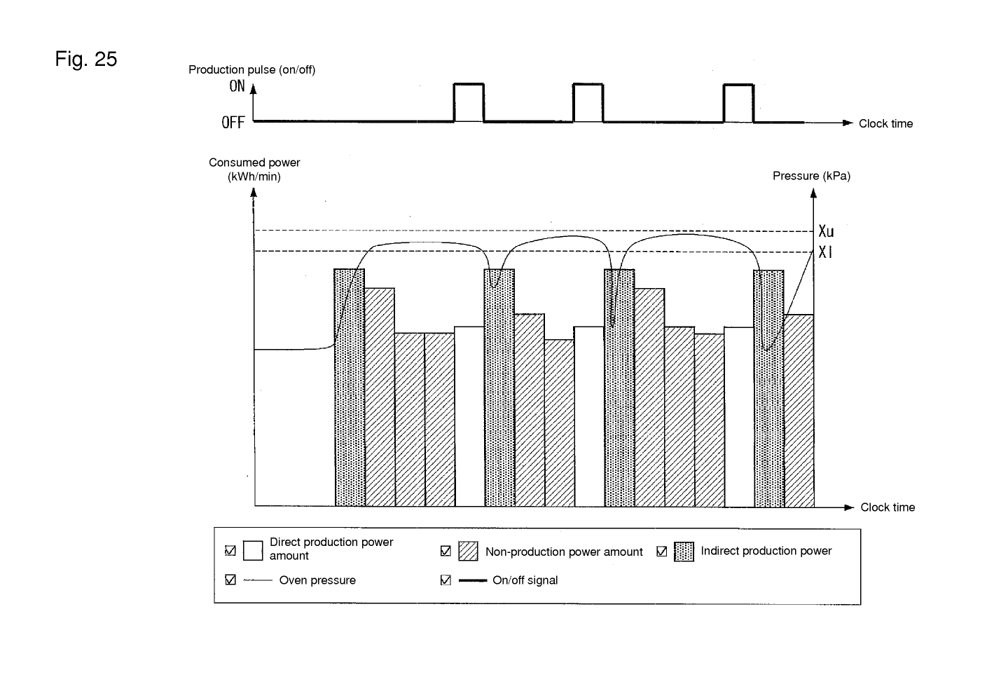

FIG. 25 is a view illustrating an example of the result graph generated by the result graph generating unit 32.

As illustrated in FIG. 25, the result graph generating unit 32 can output two two-dimensional graphs to the display unit 23. In the upper and lower graphs, the horizontal axis expresses the passage of the clock time, and the clock time and the scale are common to the upper and lower graphs.

The upper two-dimensional graph expresses the generation of the sterilization work and the time period of the generation. The time period in which the production pulse is the ON signal expresses the sterilization work state, and the time period in which the production pulse is the OFF signal expresses the sterilization preparation state (the non-production).

The lower two-dimensional graph (the bar graph) expresses the clock time and the transition of the consumed power amount of the sterilization device 6a. The bar graph also expresses the discrimination result of the consumed power. The graph (the line graph or the approximate curve graph) indicating the transition of the vapor pressure in the sterilization tank 9c may be plotted in the lower two-dimensional graph.

In the production management system 400, the sterilization tank 9c is started up (the vapor pressure is caused to reach the proper range) before the sterilization work is performed. The state of “start-up” is observed during the time interval in which the vapor pressure is less than a proper lower limit XI while the production pulse is the OFF signal. A label (colored) of the “indirect production power” is added to the bar graph of the power consumed during the time interval. Then, the sterilization preparation may be performed such that the work piece 14 standing by in the sterilization device 6a is placed in a proper position of the sterilization tank 9c. The state of “standby” is observed during the time interval in which the vapor pressure is greater than or equal to the proper lower limit XI while the production pulse is the OFF signal. The label (colored) of the “non-production power” is added to the bar graph of the power consumed during the time interval. When the worker presses the start button 16a while the placement of the work piece 14 is completed, the sterilization device 6a starts the sterilization work. The label (colored) of the “direct production power” is added to the bar graph of the power consumed during the time interval. When the predetermined time elapses, the sterilization work is ended, to take off the work piece 14 from the sterilization tank 9c. In the embodiment, the vapor pressure is temporarily lowered below the lower limit in the time period in which the sterilization tank 9c is opened in order to take off the work piece. Therefore, when the takeoff of the work piece is completed, the start-up of the sterilization device 6a is started again for the purpose of the sterilization work before the next work piece is input. The above production cycle is repeated.

In the result graph in FIG. 25, the bar graph expressing the power used amount is displayed while the color coding corresponding to the power discriminating label is performed to the bar graph. Therefore, the user can check the waste of the consumed power at a glance by checking the result graph from the display unit 23.

When the result graph is used, the waste can be reduced by the following analysis. For example, the consumed power is always kept constant without variation in the time periods of the “start-up” and “normal production”. Therefore, any person can roughly understand the time for the time periods of the “start-up” and “normal production”. On the other hand, the period of the “standby (sterilization preparation state)” varies. It is found that the waste of the power is generated with increasing standby time (specifically, the time from when the previous work piece is taken off to when the sterilization work for the next work piece is prepared).

Therefore, in the production management system 400, in order to most efficiently reduce the waste of the power, it is easily understood that, by paying attention to the period of “standby (sterilization preparation state)”, a work content is reviewed to perform the improvement.

Thus, the result graph generated by the result graph generating unit 32 largely contributes to the presentation to the user of the problematic point and improvement of the current production management system.

The present invention is not limited to the embodiments, but various changes can be made without departing from the scope of the invention. An embodiment obtained by properly combining technical means disclosed in the different embodiments is also included in the technical scope of the present invention.

Each block of the production management device 1, particularly the state determining unit 30, the power discriminating unit 31, the result graph generating unit 32, and the data processing unit 33 may be constructed by a hardware logic, or by software using a CPU (Central Processing Unit).

That is, the production management device 1 includes the CPU that executes a command of the control program implementing each function, a ROM (Read Only Memory) in which the control program is stored, a RAM (Random Access Memory) in which the control program is expanded, and storage devices (the recording medium), such as a memory, in which the control program and various pieces of data are stored. The object of the present invention can also be achieved such that the recording medium in which a program code (an executable format program, an intermediate code program, a source program) of the control program for the production management device 1, which is of the software implementing the above functions, is stored while being readable by a computer is supplied to the production management device 1, and such that the computer (or the CPU or an MPU) reads and executes the program code recorded in the recording medium.

Examples of the recording medium include tape systems, such as a magnetic tape and a cassette tape, disk systems including such magnetic disks as a floppy disk (registered trademark) and a hard disk and such optical disks as a CD-ROM, an MO an MD, a DVD, and a CD-R, card systems, such as an IC card (including a memory card) and an optical card, and semiconductor memory systems, such as a mask ROM, an EPROM, an EEPROM and a flash ROM.

The production management device 1 may be configured to be able to be connected to a communication network, and the program code may be supplied through the communication network. There is no particular limitation to the communication network. Examples of the communication network include the Internet, an intranet, an extranet, a LAN, an ISDN, a VAN, a CATV communication network, a virtual private network, a telephone line network, a mobile communication network, and a satellite communication network. There is no particular limitation to a transmission medium constituting the communication network. Examples of the transmission medium include wired lines, such as IEEE 1394, a USB, a power-line carrier, a cable TV line, a telephone line, and an ADSL line, and wireless lines, such as infrared rays, such as IrDA and a remote controller, Bluetooth (registered trademark), 802.11 wireless, HDR, a mobile phone network, a satellite line, and a terrestrial digital network. The present invention may be implemented in the form of a computer data signal, which is embodied by electronic transmission of the program code and buried in the carrier wave.

The following configurations are also included in the present invention.

The state determination means may determine the state of the production device as a start-up state meaning a state for normal production action in a period from when the production device starts the resource consumption to when the environment change physical amount changed by the production device reaches a production proper range.

According to the configuration, the process, in which the environment change physical amount is caused to reach the production proper range at the stage (that is, the non-production state in which the product is not produced) before the production device actually starts the production action, is positioned as a preparation stage for the normal production, and the preparation stage can be distinguished from the solely wasted non-production state, and positioned as the “start-up” state.

Therefore, from the viewpoint of the operation/non-operation or production/non-production, the consumption resource that is possibly determined to be wasted can correctly be discriminated as the consumption resource.

Preferably the production management device further includes: consumed physical amount acquisition means for acquiring a physical amount of the resource consumed by the production device as a consumed physical amount; and resource discriminating means for discriminating whether, according to the state determined by the state determination means, the consumed physical amount of the resource consumed in the period in which the production device is in the state is uselessly consumed.

According to the configuration, based on the state of the production device, which is determined by the state determination means from the viewpoint of extracting the waste, the resource discriminating means discriminates the waste of the resource consumed in the state.

Specifically, the resource that is consumed when the production device performs the activity contributing to the production is discriminated as the necessary consumption, and the resource that is consumed when the production device does not contribute to the production is discriminated as the wasted consumption. Additionally, the consumed physical amount acquisition means acquires the consumed physical amount of the consumed resource, so that the production management device of the present invention can demonstrate how much resource is uselessly (or efficiently) consumed by the production device in a certain state.

The resource discriminating means of the production management device may discriminate that the consumed physical amount of the resource consumed in the period in which the production device is in the start-up state is not uselessly wasted, when the state determination means of the production management device determines the state of the production device as the start-up state for the normal production action in the period from when the production device starts the resource consumption to when the environment change physical amount changed by the production device reaches the production proper range.

Therefore, from the viewpoint of the operation/non-operation or production/non-production, the consumption resource that is possibly determined to be wasted can correctly be discriminated as the consumption resource.

The production management device of the present invention may further include a sensing unit that senses whether the production device changes the physical amount of the production environment to perform production action to a work object, wherein the state determination means determines the state of the production device as a standby state wherein the standby state is a state in which the production action is not performed although the production action can be performed in a period from when the environment change physical amount changed by the production device reaches the production proper range to when the sensing unit senses the performance of the production action.

According to the configuration, the standby state that “the production is not performed although the normal production action can be performed” can be identified in consideration of the information on the production/non-production sensed by the sensing unit in addition to the environment change physical amount.

The waste of the resource consumed at that time can be discriminated by identifying the standby state.

The production management device of the present invention may further include: consumed physical amount acquisition means for acquiring a physical amount of the resource consumed by the production device as a consumed physical amount; and resource discriminating means for discriminating whether, according to the state determined by the state determination means, the consumed physical amount of the resource consumed in the period in which the production device is in the state is uselessly consumed, wherein the resource discriminating means discriminates that the consumed physical amount of the resource consumed in the period in which the production device is in the standby state is uselessly consumed when the state determination means determines the state of the production device as the standby state.

According to the configuration, the standby state that “the production is not performed although the normal production action can be performed” can be identified in consideration of the information on the production/non-production sensed by the sensing unit in addition to the environment change physical amount.

The resource consumed at that time can be discriminated as the wasted consumption by the identification of the standby state, and the uselessly consumed physical amount can be demonstrated.

The state determination means of the production management device may determine the state of the production device as a production state wherein the production state is a state in which the production is performed, in a period in which the sensing unit senses the performance of the production action while the environment change physical amount changed by the production device reaches the production proper range.

According to the configuration, the state of the production device that is normally performs the production activity, namely, contributes directly to the production can be identified as the “production state”. The waste of the consumption resource can correctly be discriminated based on the production state.

The production management device may further include resource discriminating means for discriminating whether, according to the state determined by the state determination means, the consumed physical amount of the resource consumed in the period in which the production device is in the state is uselessly consumed, wherein the state determination means determines the state of the production device as a start-up state meaning a state for normal production action in a period from when the production device starts the resource consumption to when the environment change physical amount changed by the production device reaches a production proper range, and the resource discriminating means discriminates the consumed physical amount of the resource consumed in the period in which the production device is in the start-up state as an indirect production consumed amount meaning that the consumed physical amount of the resource contributes indirectly to the production, discriminates the consumed physical amount of the resource consumed in the period in which the production device is in the standby state as a non-production consumed amount meaning that the consumed physical amount of the resource does not contribute to the production, and discriminates the consumed physical amount of the resource consumed in the period in which the production device is in the production state as a direct production consumed amount meaning that the consumed physical amount of the resource contributes directly to the production.

According to the configuration, in consideration of the environment change physical amount, first, the state determination means can identify the state of the production device as the “start-up state” meaning the preparation stage for the normal production action, in the period from when the production device starts the consumption of the resource to when the environment change physical amount changed by the production device reaches the production proper range. Secondly, the state determination means can identify the “standby state” meaning that the production is not performed although the normal production action can be performed in consideration of the information on the production/non-production sensed by the sensing unit in addition to the environment change physical amount. Thirdly, the state determination means can identify the state of the production device as the “production state”, because the resource contributes directly to the production in the period in which the sensing unit senses the performance of the production action while the environment change physical amount acquired by the production device reaches the production proper range.

Then, according to the state determined by the state determination means, the resource discriminating means discriminates whether the consumed physical amount of the resource consumed in the period in which the production device is in the state is uselessly consumed.

Specifically, the resource discriminating means can discriminate the consumed physical amount of the resource consumed in the period in which the production device is in the “start-up state” as the “indirect production consumed amount” meaning that the resource contributes indirectly to the production, discriminate the consumed physical amount of the resource consumed in the period in which the production device is in the “standby state” as the “non-production consumed amount” meaning that the resource does not contribute to the production, and discriminate the consumed physical amount of the resource consumed in the period in which the production device is in the “production state” as the “direct production consumed amount” meaning that the resource contributes directly to the production.

Therefore, how much resource is consumed in what way can be demonstrated. Specifically, how the resource is consumed is demonstrated means the discrimination whether the consumption of the resource is wasted. Alternatively, whether the consumption of the resource contributes directly to the production (the necessary consumption), whether the consumption of the resource contributes indirectly to the production (the necessary consumption), or whether the consumption of the resource does not contribute to the production (the wasted consumption) may be discriminated.

The production device may include a plurality of mechanisms having different proper ranges of the environment change physical amount, the environment change physical amount acquisition means acquires the environment change physical amount from each of the mechanisms, and the state determination means determines the state of the production device according to a combination of the plurality of environment change physical amounts acquired from the mechanisms by the environment change physical amount acquisition means.

In the case that the production device includes the plurality of mechanisms, the states depend on each mechanism. Specifically, although the normal production is not established unless all the mechanisms reach the production proper range, all the mechanisms do not necessarily reach the production proper range. That is, possibly the environment change physical amount reaches the production proper range in one of the mechanisms while the environment change physical amount reaches the production proper range in the other mechanism.

According to the configuration, the state determination means acquires the environment change physical amount from each mechanism, combines the environment change physical amounts of the mechanisms, and comprehensively determines the state of the production device.

Accordingly, even if the production device includes the plurality of mechanisms, irrespective of the operation/non-operation of the production device, the waste of the consumption resource can correctly be discriminated by properly determining the state of the production device.

The state determination means may determine the state of the production device as a start-up state meaning a state for normal production action in a predetermined period when a rate of change of the environment change physical amount in the period is greater than a predetermined threshold, the rate of change of the environment change physical amount being obtained based on the environment change physical amount acquired by the environment change physical amount acquisition means.

During the start-up, the environment change physical amount of the production device changes largely in the relatively short period until the physical amount reaches the production proper range from the pre-operation physical amount. When reaching the production proper range, the environment change physical amount is stabilized for a long time in order to maintain the production proper range.

Therefore, the large change of the physical amount in the relatively short period is recognized by the configuration, and the period can be determined as the start-up state.

The environment change physical amount acquisition means may acquire temperature information as the environment change physical amount changed by the production device.

According to the configuration, in the case that the production device acquires the temperature environment higher or lower than room temperature to produce the product by consuming the resource, the waste of the consumption resource can correctly be discriminated by properly determining the state of the production device.

More specifically, for example, in the case that the production device is the device that acquires the high- or low-temperature environment to produce the product by consuming the power, the state of the production device can be determined based on the temperature information on the mechanism currently operating in the production device. The wasted power consumed by the production device can be discriminated based on the determined state.

The production management system may further include a consumed physical amount measurement unit that measures the physical amount of the resource consumed by the production device as a consumed physical amount, wherein the production management device discriminates whether, according to the determined state of the production device, the consumed physical amount of the resource consumed in the period in which the production device is in the state is uselessly consumed. The production management system may further include a sensing unit that senses whether the production device changes the physical amount of the production environment to perform production action to a work object, wherein the production management device determines the state of the production device based on the environment change physical amount acquired by the environment change physical amount measurement unit and existence or non-existence of the production action of the production device, which is sensed by the sensing unit.

### INDUSTRIAL APPLICABILITY

The present invention is used to measure the environment change physical amount changed by operating the production device that consumes the resource to perform the production, and to discriminate the waste of the consumed physical amount consumed by the production device. Specifically, for example, the production management device of the present invention can measure the physical amount (change amount) to discriminate the waste of the consumption of the consumed physical amount (the physical amount, such as the power, the water, the gas, and the gasoline) in the case that the drying oven, the sterilization device, the washing machine, the compressor, the cooling device, and the NC machine (Numeral Control machine), which are of the production device, operate to change the physical amount, such as the temperature, the atmospheric pressure, the vapor pressure, the pressure, the humidity, the degree of oxygen saturation, and the density of the specific substance, which are of the environment change physical amount.

1. A production management device configured to monitor a state of a production device, the production device being configured to perform production with a change in a physical amount of a production environment by consuming a resource, the production management device comprising:
an environment change physical amount acquisition unit configured to acquire the physical amount of the production environment as an environment change physical amount, the physical amount of the production environment being changed by the production device consuming the resource; and
a state determining unit configured to determine the state of the production device based on the environment change physical amount acquired by the environment change physical amount acquisition measurement unit.

2. The production management device according to claim 1, wherein the state determining unit is configured to determines the state of the production device as a start-up state wherein the start-up state is a state for normal production action in a period from when the production device starts the resource consumption to when the environment change physical amount changed by the production device reaches a production proper range.

3. The production management device according to claim 1, further comprising:
a consumed physical amount acquisition unit configured to acquire a physical amount of the resource consumed by the production device as a consumed physical amount; and
a resource discriminating unit configured to discriminate whether, according to the state determined by the state determining unit, the consumed physical amount of the resource consumed in the period in which the production device is in the state is uselessly consumed.

4. The production management device according to claim 3, wherein
the resource discriminating unit is configured to discriminates that the consumed physical amount of the resource consumed in the period in which the production device is in the start-up state is not uselessly consumed,
when the state determining unit determines the state of the production device as the start-up state wherein the start-up state is a state for the normal production action in the period from when the production device starts the resource consumption to when the environment change physical amount changed by the production device reaches the production proper range.

5. The production management device according to claim 1, further comprising a sensing unit configured to senses whether the production device changes the physical amount of the production environment to perform production action to a work object,
wherein the state determining unit is configured to determines the state of the production device as a standby state wherein the standby state is state in which the production action is not performed although the production action can be performed in a period from when the environment change physical amount changed by the production device reaches the production proper range to when the sensing unit senses the performance of the production action.

6. The production management device according to claim 5, further comprising:
a consumed physical amount acquisition unit configured to acquire a physical amount of the resource consumed by the production device as a consumed physical amount; and
a resource discriminating unit configured to discriminate whether, according to the state determined by the state determining unit, the consumed physical amount of the resource consumed in the period in which the production device is in the state is uselessly consumed,
wherein the resource discriminating unit is configured to discriminates whether the consumed physical amount of the resource consumed in the period in which the production device is in the standby state is uselessly consumed
when the state determining unit determines the state of the production device as the standby state.

7. The production management device according to claim 5, wherein the state determining unit is configured to determines the state of the production device as a production state wherein the production state is a state in which the production action is performed, in a period in which the sensing unit senses the performance of the production action while the environment change physical amount changed by the production device reaches the production proper range.

8. The production management device according to claim 7, further comprising:
a resource discriminating unit configured to discriminate whether, according to the state determined by the state determining unit, the consumed physical amount of the resource consumed in the period in which the production device is in the state is uselessly consumed,
wherein the state determining unit is configured to determines the state of the production device as a start-up state wherein the start-up state is a state for normal production action in a period from when the production device starts the resource consumption to when the environment change physical amount changed by the production device reaches a production proper range,
and the resource discriminating unit is configured to:
(i) discriminates the consumed physical amount of the resource consumed in the period in which the production device is in the start-up state as an indirect production consumed amount,
(ii) discriminates the consumed physical amount of the resource consumed in the period in which the production device is in the standby state as a non-production consumed amount, and
(iii) discriminates the consumed physical amount of the resource consumed in the period in which the production device is in the production state as a direct production consumed amount.

9. The production management device according to claim 1, wherein the production device includes a plurality of mechanisms having different proper ranges of the environment change physical amount,
the environment change physical amount acquisition unit is configured to acquires the environment change physical amount from each of the mechanisms, and
the state determination unit is configured to determines the state of the production device according to a combination of the plurality of environment change physical amounts acquired from the mechanisms by the environment change physical amount acquisition unit.

10. The production management device according to claim 1, wherein the state determining unit is configured to determines the state of the production device as a start-up state wherein the start-up state is a state for normal production action in a predetermined period, and
when a rate of change of the environment change physical amount in the predetermined period is greater than a predetermined threshold, the rate of change of the environment change physical amount being obtained based on the environment change physical amount acquired by the environment change physical amount acquisition unit.

11. The production management device according to claim 1, wherein the environment change physical amount acquisition unit is configured to acquire temperature information as the environment change physical amount changed by the production device.

12. A production management system comprising:
a production device configured to performs production with a change in a physical amount of a production environment by consuming a resource;
a production management device configured to monitor a state of the production device; and
an environment change physical amount measurement unit configured to measure the physical amount, which is changed by the production device consuming the resource, as an environment change physical amount,
wherein the production management device is configured to determine the state of the production device based on the environment change physical amount measured by the environment change physical amount measurement unit.

13. The production management system according to claim 12, further comprising a consumed physical amount measurement unit configured to measures the physical amount of the resource consumed by the production device as a consumed physical amount,
wherein the production management device is configured to discriminates whether, according to the determined state of the production device, the consumed physical amount of the resource consumed in the period in which the production device is in the state is uselessly consumed.

14. The production management system according to claim 12, further comprising a sensing unit configured to sense whether the production device changes the physical amount of the production environment to perform production action to a work object,
wherein the production management device is configured to determines the state of the production device based on the environment change physical amount acquired by the environment change physical amount measurement unit and existence or non-existence of the production action of the production device, which is sensed by the sensing unit.

15. A method of controlling a production management device configured to monitor a state of a production device, the production device configured to perform production with a change in a physical amount of a production environment by consuming a resource, the method of controlling the production management device comprising:
an environment change physical amount acquisition step of acquiring the physical amount of the production environment as an environment change physical amount, the physical amount of the production environment being changed by the production device consuming the resource; and
a state determination step of determining the state of the production device based on the environment change physical amount acquired in the environment change physical amount acquisition step.

16. (canceled)

17. A computer-readable recording medium, having stored thereon a control program including instructions which when executed on a computer, causes the computer to act as each unit of the production management device according to claim 1.
